(19) United States
(12) Patent Application Publication
(10) Pub. No.: US 2026/0003919 A1
(43) Pub. Date: Jan. 1, 2026

(54) TECHNIQUES FOR ADAPTIVE MULTI-LEVEL RECOMMENDATION USING HIERARCHICAL MIXTURE-OF-EXPERTS FRAMEWORK

(71) Applicant: NETFLIX, INC., Los Gatos, CA (US)

(72) Inventors: Maryam ESMAEILI, Seattle, WA (US); Justin Derrick BASILICO, Los Gatos, CA (US); Christoph KOFLER, Los Gatos, CA (US); Inbar NAOR, San Francisco, CA (US); Jiangwei PAN, Los Gatos, CA (US); Jin WANG, Kirkland, WA (US)

(21) Appl. No.: 18/824,687

(22) Filed: Sep. 4, 2024

Related U.S. Application Data
(60) Provisional application No. 63/665,769, filed on Jun. 28, 2024.

(51) Int. Cl. G06F 16/9535; H04N 21/466

(52) U.S. Cl. CPC G06F 16/9535; H04N 21/4668

(57) ABSTRACT

Techniques for adaptive multi-level recommendation include processing input features to generate pre-processed input features, processing the input features and the pre-processed input features using a plurality of expert models to generate expert outputs, mixing the input features and the expert outputs to generate mixed expert outputs, processing the mixed expert outputs using a first model of the hierarchical model to generate intermediate outputs, and processing the mixed expert outputs and the intermediate outputs using a second model of the hierarchical model to generate a final output.

### CROSS-REFERENCE TO RELATED APPLICATIONS

This application claims priority benefit of the U.S. Provisional patent application titled, “TECHNIQUES FOR ADAPTIVE MULTI-LEVEL RECOMMENDATION USING HIERARCHICAL MIXTURE-OF-EXPERTS FRAMEWORK,” filed on Jun. 28, 2024, and having Ser. No. 63/665,769. The subject matter of this related application is hereby incorporated herein by reference.

### BACKGROUND

### Technical Field

The embodiments of the present disclosure relate generally to computer science and machine learning, and more specifically, to techniques for adaptive multi-level recommendation using a hierarchical Mixture-of-Experts (MoE) framework.

### Description of the Related Art

Recommendation systems, also known as recommender systems, are tools designed to predict users' preferences for items such as movies, books, products, services, and/or the like, based on various algorithms and data sources. Recommendation systems play a role in enhancing user experience across platforms, such as e-commerce sites, streaming services, social media, and/or the like. For example, on-line retailers use recommendation systems to suggest products that a customer could be interested in based on browsing history and previous purchases of that customer. Similarly, content streaming services, such as Netflix, employ recommendation systems to recommend movies and TV shows by analyzing viewing habits and comparing the viewing habits with the preferences of other users with similar tastes.

One conventional approach used in recommendation systems includes content-based filtering, which recommends items similar to those a user has liked in the past. For example, a user who has watched and liked several science fiction movies could receive recommendations for other science fiction content. Content-based filtering relies on the attributes of the items and the user's historical interactions with the attributes. Another conventional approach used in recommendation systems includes collaborative filtering, which suggests items liked by similar users. For example, the “customers who bought this item also bought” feature used by an on-line retailer is a recommendation system based on collaborative filtering where the recommendation system suggests products based on the purchasing patterns of other users with similar interests.

One drawback of conventional recommendation systems is the tendency to generate recommendations that lack diversity. In content-based filtering, because the recommendation system relies on the attributes of items that a user has already interacted with, the recommendation system often suggests items that are very similar to the items previously liked by the user, which can lead to a narrow set of recommendations. In collaborative filtering, recommendation systems generate recommendations that reflect the preferences of the majority, potentially ignoring niche interests and leading to a homogenized set of recommendations that may not cater to individual user preferences, leading to a phenomenon, often referred to as the “filter bubble,” which can limit users' exposure to diverse content and reinforce existing preferences.

Another drawback of conventional recommendation systems is the cold start problem, which occurs when there is insufficient data on new users or items. In content-based filtering, recommendation systems struggle with new or less popular items that do not have a well-defined set of attributes or sufficient user interaction data. In collaborative filtering, recommendation systems struggle to make accurate suggestions for new users who have not rated many items or for new items that have not been rated by many users, because conventional recommendation systems with collaborative filtering generate recommendations based on the overlap of user interactions.

Yet another drawback of conventional recommendation systems is the computational complexity involved in generating accurate and timely recommendations. In content-based filtering, the recommendation system has to analyze and compare a vast number of item attributes for each user, which can be computationally intensive, especially as the dataset grows. Similarly, in collaborative filtering, the recommendation system faces scalability issues as the number of users and items increases. The recommendation system has to perform extensive calculations to find similar users or items, which can lead to performance bottlenecks and slow down the recommendation process. The computational burden is exacerbated in large-scale applications like e-commerce and streaming services, where real-time recommendations are of interest for enhancing user experience.

As the foregoing illustrates, what is needed in the art are more effective techniques for recommendation systems.

### SUMMARY

One embodiment of the present disclosure sets forth a computer-implemented method for generating recommendations using a hierarchical model. The method includes processing input features to generate pre-processed input features, processing the input features and the pre-processed input features using a plurality of expert models to generate expert outputs, mixing the input features and the expert outputs to generate mixed expert outputs, processing the mixed expert outputs using a first model of the hierarchical model to generate intermediate outputs, and processing the mixed expert outputs and the intermediate outputs using a second model of the hierarchical model to generate a final output.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, diverse and personalized recommendations can be generated that address a wide range of user preferences and contexts. The disclosed techniques dynamically balance shared and task-specific knowledge, ensuring that the most relevant and diverse recommendations are provided to each user. Another advantage of the disclosed techniques is the ability to address the cold start problem by recommending new or less popular items for users from sparse interaction data. Yet another advantage of the disclosed techniques is the reduction in computational cost compared to conventional recommendation systems by reusing previously computed results and minimizing redundant calculations, which reduces the computational burden associated with analyzing and comparing a large number of item attributes or user interactions. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure;

FIG. 2 is a block diagram of a content server that can be implemented in conjunction with the network infrastructure of FIG. 1, according to various embodiments of the present disclosure;

FIG. 3 is a block diagram of a control server that can be implemented in conjunction with the network infrastructure of FIG. 1, according to various embodiments of the present disclosure; and

FIG. 4 is a block diagram of an endpoint device that can be implemented in conjunction with the network infrastructure of FIG. 1, according to various embodiments of the present disclosure;

FIG. 5 is a block diagram of a computer-based system according to various embodiments;

FIG. 6 is a more detailed illustration of the recommendation application of FIG. 5, according to various embodiments;

FIG. 7 is an example of the recommendation application of FIG. 6, according to various embodiments;

FIG. 8 illustrates a row adaptor model which is an example of the first model of FIG. 5, according to various embodiments;

FIG. 9 illustrates an adaptive row ordering model which is an example of the second model of FIG. 5, according to various embodiments;

FIG. 10 illustrates a more detailed illustration of the model trainer of FIG. 5, according to various embodiments;

FIG. 11 illustrates a more detailed illustration of the multi-level scoring module of FIG. 5, according to various embodiments;

FIG. 12A illustrates an example of the model trainer of FIG. 5 during the forward pass of training, according to various embodiments;

FIG. 12B illustrates an example of the model trainer of FIG. 5 during a backward pass of training, according to various embodiments;

FIG. 13A illustrates an example of the multi-level scoring module of FIG. 5 without using cached intermediate outputs during inference, according to various embodiments;

FIG. 13B illustrates an example of multi-level scoring module of FIG. 5 while using cached intermediate outputs during inference, according to various embodiments;

FIG. 14 sets forth a flow diagram of method steps for processing input features and generating final output, according to various embodiments;

FIG. 15 sets forth a flow diagram of method steps for training a hierarchical model, according to various embodiments; and

FIG. 16 sets forth a flow diagram of method steps for inferencing final output with cached intermediate outputs, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### System Overview

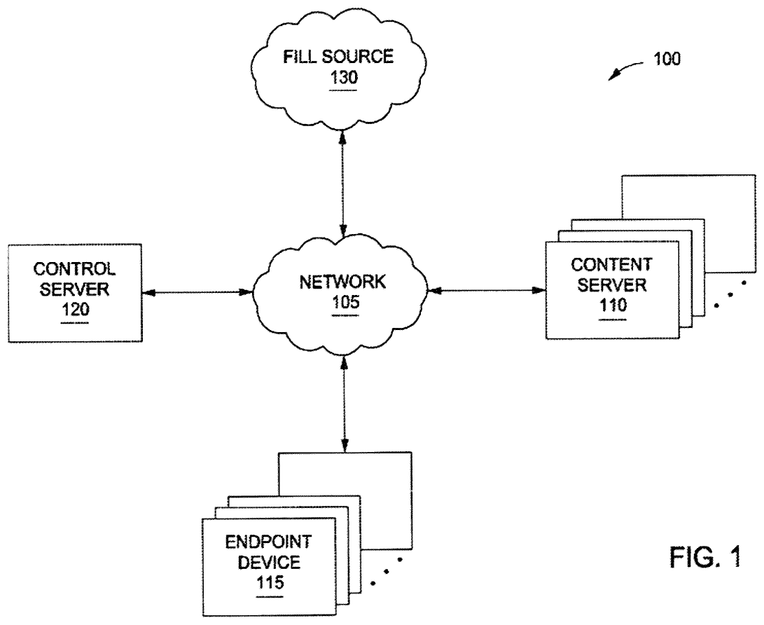

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

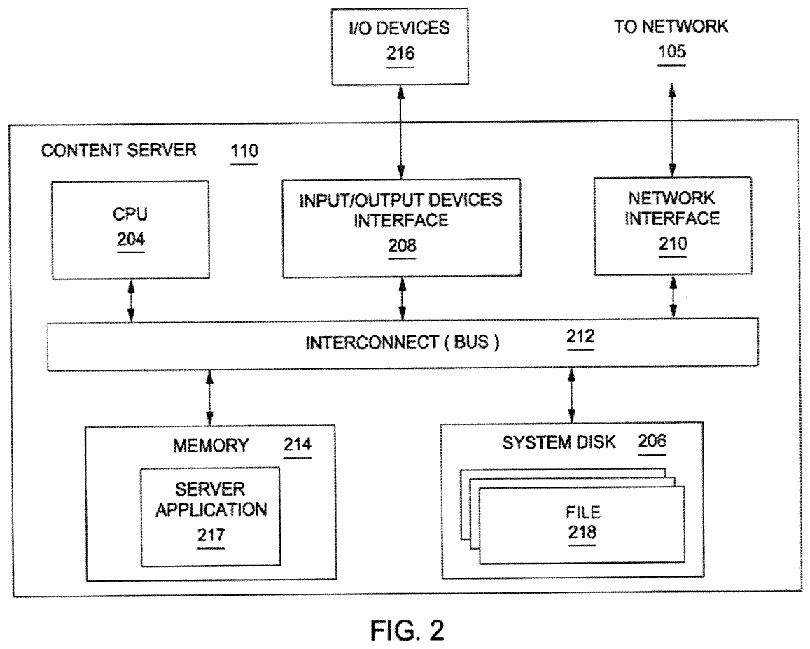

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

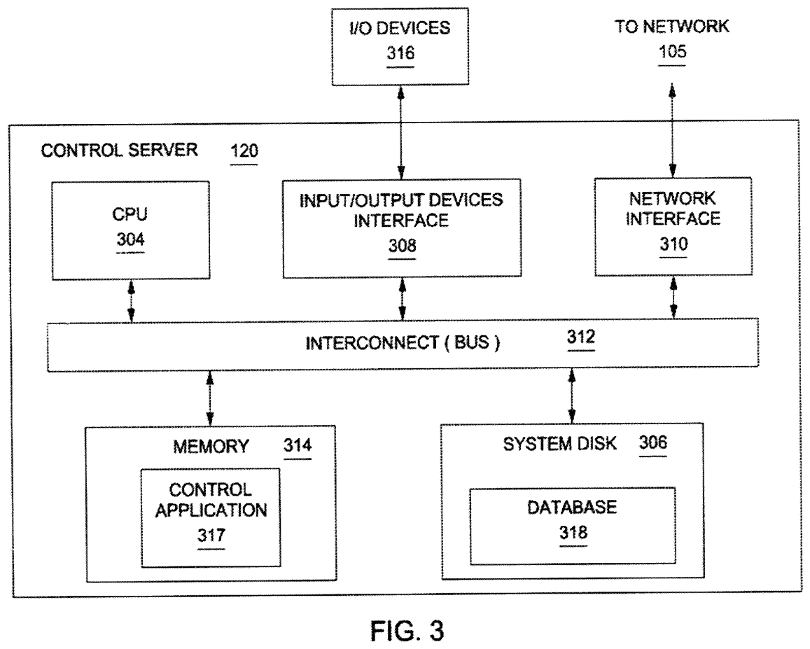

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

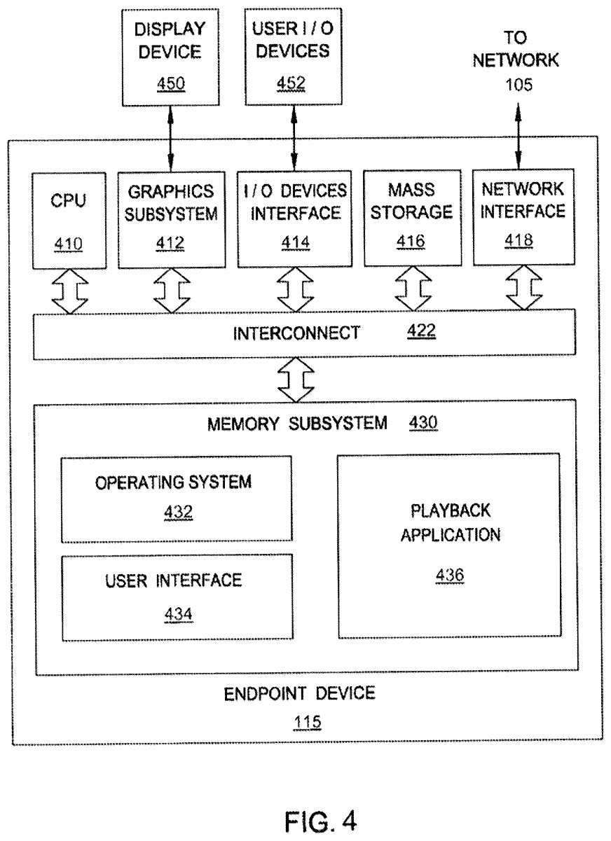

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Multi-Level Recommendation Using Hierarchical Mixture-of-Experts Framework

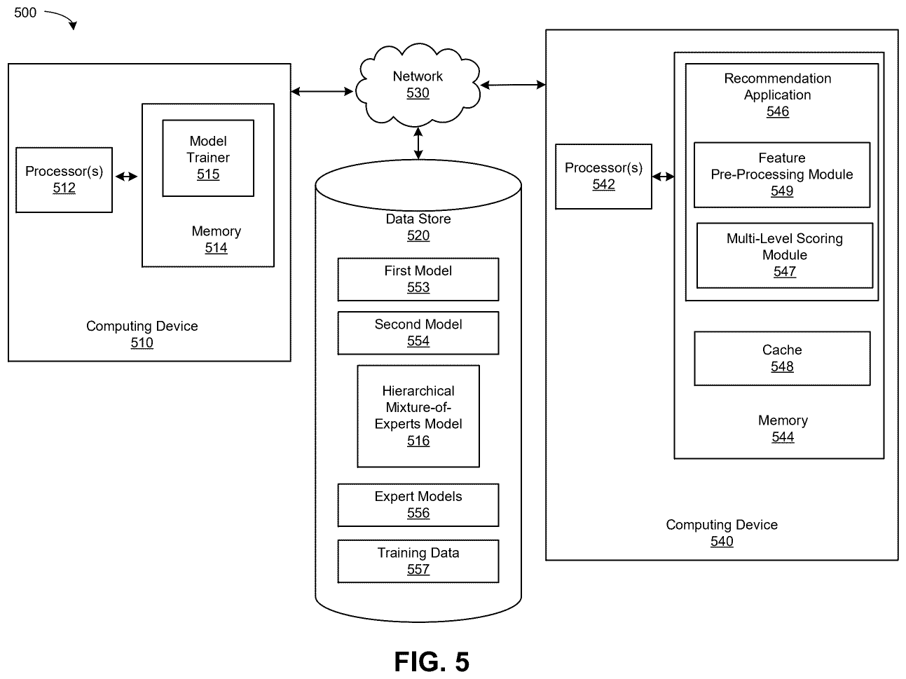

FIG. 5 is a block diagram of a computer-based system 500 according to various embodiments. As shown, computer-based system 500 includes, without limitation, computing devices 510 and 540, a data store 520, and a network 530. Computing device 510 includes, without limitation, one or more processors 512 and memory 514. Memory 514 includes, without limitation, a model trainer 515. Data store 520 includes, without limitation, a first model 553, a second model 554, a hierarchical MoE model 516, expert models 556, and training data 557. Computing device 540 includes, without limitation, one or more processors 542 and memory 544. Memory 544 includes, without limitation, a recommendation application 546 and a cache 548. And although the embodiments of FIG. 5 are described in the context of recommendation systems, it is understood that the disclosed techniques are also applicable to other areas of machine learning, such as classifiers, natural language processing models, anomaly detection systems, and predictive maintenance applications, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications. During operation, processor(s) 512 can receive user input from input devices (not shown), such as a keyboard or a mouse.

Memory 514 of computing device 510 stores content, such as software applications and data, for use by processor(s) 512. As shown, memory 514 includes, without limitation, model trainer 515. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

Model Trainer 515 is stored in memory 514 and is executed by processor(s) 512. Model trainer 215 uses training data 557 to train one or more gating mechanisms in hierarchical MoE model 516, expert models 556, first model 553, and second model 554. Training data 557 includes features that captures various aspects of user interactions, item characteristics, contextual factors, and/or the like and the corresponding final outputs, such as recommendations based on features. For example, in a media recommendation system, training data 557 can include user ratings, viewing history, genre preferences, demographic information, and/or the like. Additionally, metadata about the media content items, such as genres, actors, directors, release dates, and/or the like, can be included in training data 557. In e-commerce, training data 557 can include user purchase history, browsing behavior, product ratings, click-through rates, and/or the like, along with item attributes such as price, brand, category, customer reviews, and/or the like. Contextual features can include time of day, location, device type, and/or the like.

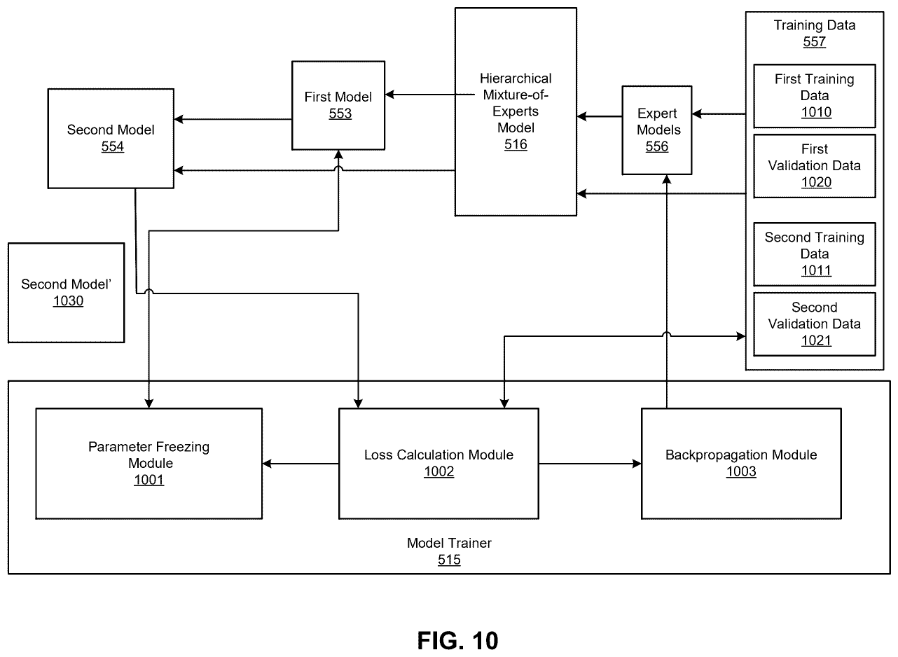

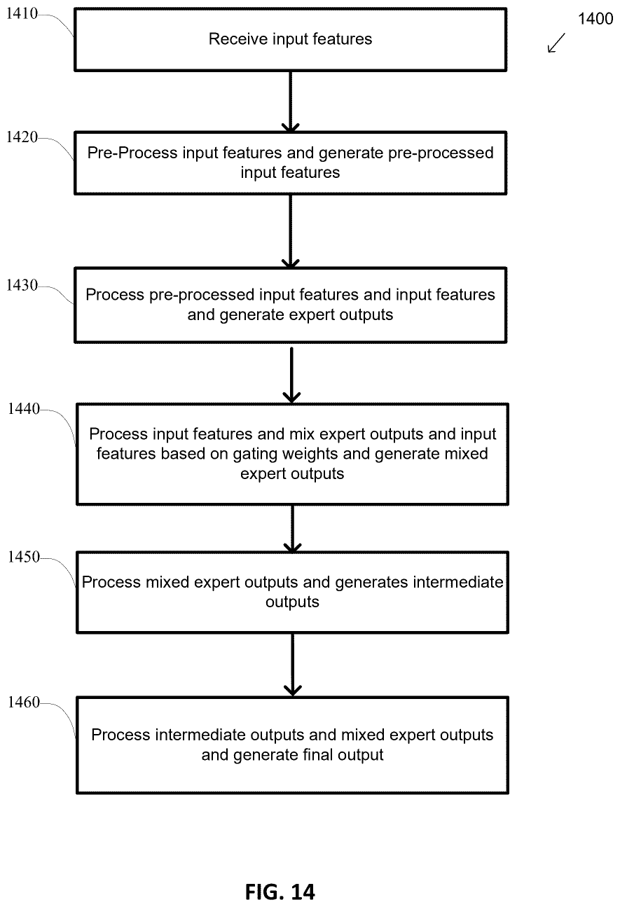

Model trainer 515 is also configured to train one or more machine learning models with training data 557, such as expert models 556, first model 553, second model 554, and gating mechanisms included in hierarchical MoE model 516, that are used to assist in generating recommendations. Model trainer 515 can employ any suitable techniques to train the machine learning model(s). For example, model trainer 515 can use techniques, such as fine-tuning with domain-specific data, transfer learning, or curriculum learning to train the one or more machine learning model(s). Model trainer 515 is discussed in greater detail below in conjunction with FIGS. 10 and 14. After model trainer 515 trains first model 553, expert models 556, second model 554, and hierarchical MoE model 516, model trainer 215 stores expert models 556, first model 553, second model 554, and hierarchical MoE model 516 in data store 520 for access by other computing devices, such as computing device 540.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing first model 553, second model 554, hierarchical MoE model 516, expert models 556, and training data 557.

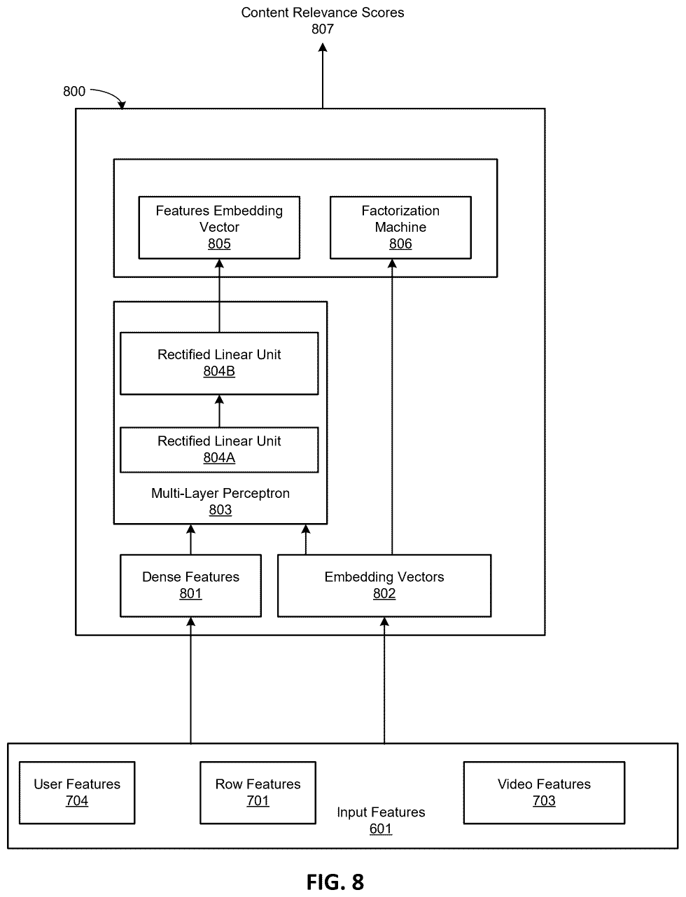

First model 553 is a machine learning model, which processes mixed expert outputs and generates an intermediate output. In various embodiments, first model 553 ranks entities within groups of entities based on various input features. First model 553 processes mixed expert outputs generated from user interactions, item attributes, contextual information, and/or the like, to generate intermediate outputs that include but are not limited to user preferences and content relevance. For example, in a media recommendation system, first model 553 can process mixed expert outputs generated using user viewing history, media content item (e.g., video) metadata such as genre and length, and contextual factors such as time of day and device type. In various embodiments, first model 553 uses various machine learning techniques, such as deep neural networks, to learn patterns and relationships within the data. The intermediate outputs generated by first model 553 include, but are not limited to, a refined representation of user preferences, which are then used by second model 554 to make final recommendations. For example, in e-commerce, first model 553 can rank products based on user browsing behavior, purchase history, and product characteristics, producing a list of ranked items that align with the user's interests. By accurately ranking entities, first model 553 ensures that the most relevant and appealing items are considered by second model 554. An example of a possible first model 553 is discussed in greater detail below in conjunction with FIG. 8.

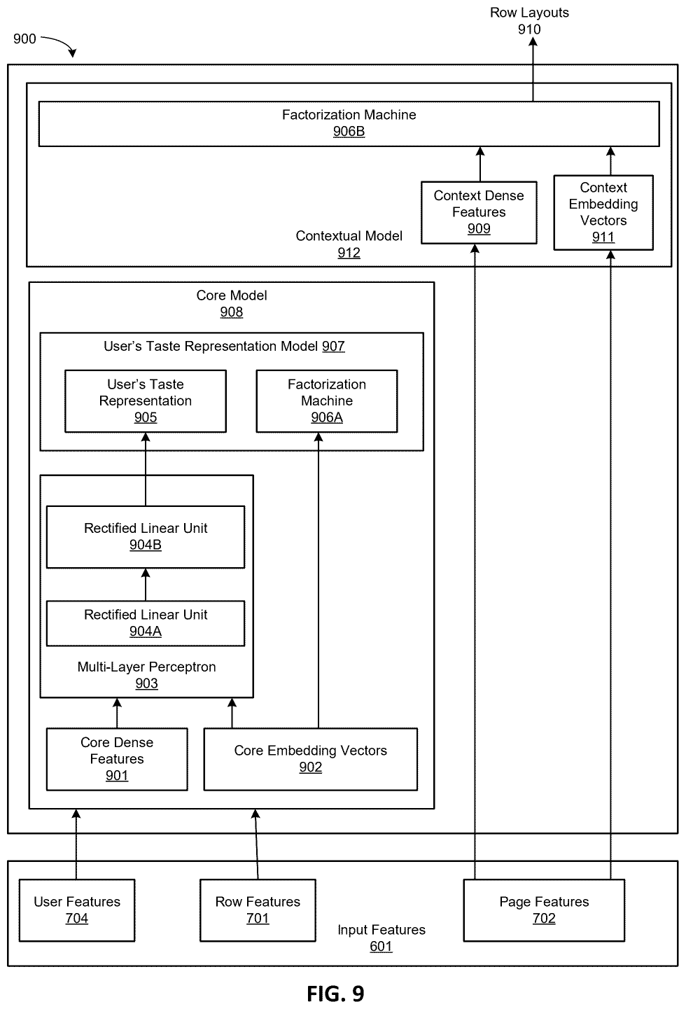

Second Model 554 is a machine learning model, which processes mixed expert outputs and intermediate outputs generated by first model 553 and generates final recommendations. In various embodiments, second model 554 selects and optimizes the presentation of recommendations based on the refined outputs from first model 553. Second model 554 uses contextual information and user interaction data to finalize the recommendations that are most likely to engage the user. For example, in a content streaming platform, second model 554 processes intermediate outputs from first model 553, such as ranked lists of media content items, and processes intermediate outputs along with additional mixed expert outputs based on contextual features, such as the user's current session behavior, device type, and recent interaction patterns. In some examples, second model 554 uses various machine learning techniques including but not limited to attention mechanisms to process various expert outputs and intermediate outputs from first model 553 to generate the final recommendation for the user's immediate context. For example, in e-commerce, second model 554 processes expert outputs based on current promotions, stock availability, and the user's recent searches, and the ranked lists of products generated by first model 553 to generates product recommendations. An example of a possible second model 554 is discussed in greater detail below in conjunction with FIG. 9.

Hierarchical MoE model 516 mixes various expert outputs which are used by first model 553 and second model 554 to generate recommendations. Hierarchical MoE model 516 includes various gating mechanisms that dynamically assign weights to the outputs of shared and task-specific expert models based on the input features. The gating mechanisms allocate weights to both second model-specific and shared expert models using, for example, combined features of user, row (e.g., groups of items), and page context, ensuring the most relevant expert outputs are used for optimizing page layout and content placement. Page layout refers to the arrangement and organization of content on the screen, including the positioning of recommendations, ads, navigation elements, selection and placement of rows, and/or the like, while page context includes the overall environment in which the user interacts with the content, such as the type of device, time of day, and user's current activity on the site, and/or the like. The selection and placement of rows include determining which rows of content to display and the order of rows on the page, so that the most relevant and engaging content is accessible to the user. Similarly, first model-specific and shared expert models are mixed using weights based on, for example, user, row, and video content features, refining video recommendations. Hierarchical mixture-of-experts model 516 processes input features and mixes the weighted expert outputs, presenting the weighted expert outputs to first model 553 and second model 554 to generate recommendations. For example, in an e-commerce platform, hierarchical MoE model 516 can mix user browsing history, product metadata, and real-time interaction data, while in a video streaming service, hierarchical mixture-of-experts model 516 can mix viewing patterns, content attributes, and contextual factors. In various embodiments, by dynamically adjusting the contributions of different expert models 556, hierarchical MoE model 516 ensures that the recommendation system remains responsive to changing user behaviors and preferences.

Expert models 556 are machine learning models that process features specific to different tasks and generate expert outputs. In some embodiments, expert models 556 are deep neural networks. Expert outputs include but are not limited to user embeddings, content embeddings, interaction scores, feature importance scores, contextual embeddings, engagement predictions, sentiment scores, and/or the like, which represent user preferences and behaviors learned from interaction data. Content embeddings are vector representations of items (e.g., videos, articles, products) that include features such as genre, style, quality, and/or the like. Interaction scores are quantitative measures derived from user interactions with content, such as click-through rates, watch time, like/dislike ratios, and/or the like. Feature importance scores indicate the significance of various input features (e.g., user demographics, content metadata) in making accurate recommendations. Contextual embeddings represent contextual factors such as time of day, device type, user location, and/or the like. Engagement predictions forecast user engagement with specific content, such as the likelihood of watching a video to completion, purchasing a recommended product, and/or the like Sentiment scores analyze user-generated content, such as reviews, comments, and/or the like, to determine overall sentiment and influence recommendations by highlighting positively received items. For example, in a media recommendation system, expert outputs can include user embeddings that capture a user's taste in media content items, content embeddings that summarize the attributes of various films, and interaction scores that reflect past viewing behaviors.

Expert models 556 include shared expert models and task-specific expert models. Shared expert models are trained to learn representations that are useful across multiple tasks, such as general user preferences, common patterns in interaction data, and/or the like. For example, a shared expert model can process combined input features such as user demographics, overall viewing history, general content metadata, and/or the like, to generate expert outputs, such as extracted features, used for both the first model 553 and the second model 554. The shared expert models can include convolutional neural networks (CNNs) that learn spatial hierarchies in data, recurrent neural networks (RNNs) that capture sequential patterns, and/or the like. In contrast, task-specific expert models are trained to process input features used for specific tasks, such as input features used in first model 553 and input features used in second model 554. For example, second model-specific expert models can process page context and user interactions, such as the sequence of page views, clicks, and/or the like, to optimize page layout and content placement. Second model-specific expert models can use various techniques including but not limited to attention mechanisms to process relevant parts of the input sequence, for example, to capture user behavior on a webpage. First model-specific expert models, on the other hand, can process video content and user-video interactions, analyzing attributes such as video length, genre, user engagement metrics, and/or the like, to refine video recommendations. First model-specific expert models can use various techniques including but not limited to long short-term memory (LSTM) networks to analyze temporal data and autoencoders to learn compact representations of video features.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user input from input devices (not shown), such as a keyboard or a mouse.

Memory 544 of computing device 540 stores content, such as software applications and data, for use by processor(s) 542. As shown, memory 544 includes, without limitation, a recommendation application 546 and a cache 548. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

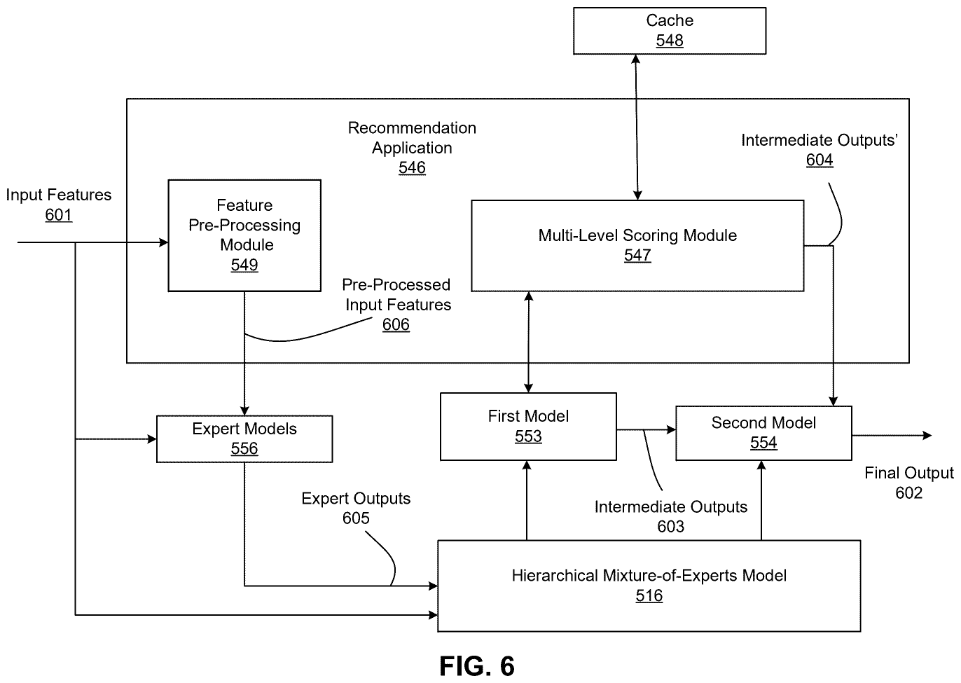

As shown, recommendation application 546 is stored in memory 544 and executes on processor(s) 542. Recommendation application 546 includes, without limitation, a feature pre-processing module 549 and a multi-level scoring module 547. Recommendation application 546 receives one or more input features via one or more I/O device(s) (not shown). Based on the one or more input features, recommendation application 546 uses expert models 556, trained gating mechanisms included in hierarchical MoE model 516, first model 553, and second model 554 to generate final recommendations. Recommendation application 546 is discussed in greater detail below in conjunction with FIGS. 6-9, 11-14 and 16.

Feature pre-processing module 549 pre-processes input features into a format suitable for analysis by expert models 556. In various embodiments, feature pre-processing module 549 pre-processes input features for various tasks, such as data cleaning, normalization, encoding categorical variables, and feature extraction. For example, in a content streaming platform, feature pre-processing module 549 can pre-process input features, such as user interaction logs, video metadata, session information, and/or the like, converting input features into pre-processed features that can be fed into expert models 556. The pre-processing ensures that the input features are standardized and scaled appropriately, enhancing the performance and accuracy of the expert models 556. Feature pre-processing module 549 can also address missing input features issues, apply transformations such as log scaling for skewed data distributions, and generate new input features through techniques such as polynomial combinations or interaction terms. In various embodiments, when the numbers of input features could be too large, feature pre-processing module 549 extracts the most important or relevant features to streamline processing. For example, feature pre-processing module 549 can identify and prioritize features, such as a user's top watch list or most frequently interacted with content.

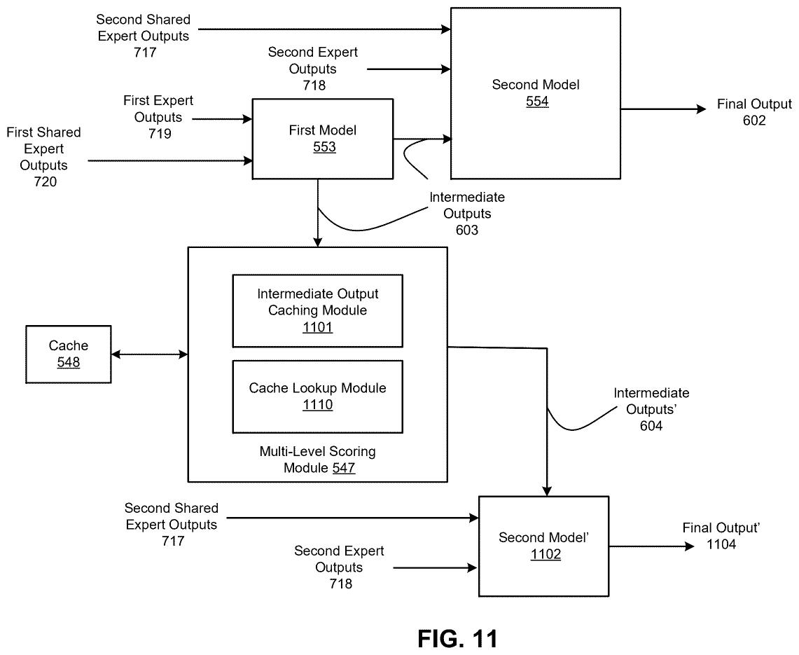

Multi-level scoring module 547 manages the storage and retrieval of intermediate outputs generated by first model 553 during the inference process. In operation, multi-level scoring module 547 captures the intermediate outputs from first model 553 and stores the intermediate outputs in cache 548 for future retrieval. In various embodiments, when similar input data is received, multi-level scoring module 547 retrieves and uses the cached intermediate outputs instead of recomputing the intermediate outputs. For example, in a content streaming platform, if a user navigates through different genres or categories during the same interaction session, multi-level scoring module 547 enables the content recommendation system to deliver personalized recommendations by retrieving previously cached data, which can include previously computed relevance scores and user preference embeddings, such as previously computed relevance scores and user preference embeddings. Multi-level scoring module 547 is discussed in greater detail below in conjunction with FIGS. 11-13 and 16.

Cache 548 is a data storage unit which stores intermediate outputs generated by first model 553. In various embodiments, cache 548 allows the recommendation system to quickly retrieve previously generated intermediate outputs when the same or similar input data is received, thereby reducing redundant computations. For example, when a user revisits a previously explored video or product category, cache 548 allows the recommendation system to generate updated recommendations without reprocessing the entire data set. In some embodiments, cache 548 supports dynamic adaptation by updating cached data as user interactions and preferences evolve, ensuring that the final recommendations remain relevant and personalized.

FIG. 6 is a more detailed illustration of recommendation application 546 of FIG. 5, according to various embodiments. As shown, recommendation application 546 includes, without limitation, feature pre-processing module 549 and multi-level scoring module 547. Recommendation application 546 processes input features 601 and interacts with expert models 556, first model 553, second model 554, hierarchical MoE model 516, and cache 548 to generate final output 602. Input Features 601 represent the raw data presented to the recommendation system. Input features 601 include various data points, including but not limited to user interaction data, item attributes, contextual information, and/or the like. For example, in a content streaming platform, input features 601 can include user watch history, ratings, search queries, video metadata, such as genre, length, and release date, and session context, such as device type, time of day, and location. In an e-commerce setting, input features can include user browsing history, purchase records, product descriptions, pricing, availability, and promotional information. If the input features 601 are diverse, the recommendation system can process multifaceted aspects of user preferences and behaviors.

In operation, feature pre-processing module 549 pre-processes various input features 601, which can include raw data such as user interaction logs, item attributes, and contextual information, generating pre-processed input features 606. For example, in a content streaming platform, raw user interaction logs can include details such as watch duration, search history, and content ratings, which feature pre-processing module 549 pre-processes to generate pre-processed input features 606 that indicate user preferences. Similar to content streaming, in an e-commerce setting, feature pre-processing module 549 normalizes and encodes product descriptions and user purchase history to highlight relevant attributes, such as product category, price range, and user demographics. Expert models 556 process pre-processed input features 606 and input features 601 and generate expert outputs 605. In various embodiments, expert models 556 include both shared and task-specific expert models. For example, in a content streaming platform, a shared expert model can process combined input features 601 such as general viewing patterns and demographic data to create user embeddings, while task-specific expert models can focus on video metadata for the first model 553 and user interaction sequences for second model 554. Hierarchical MoE model 516 processes input features 601 and uses various gating mechanisms to mix various expert outputs 605 and generates first model-specific expert outputs, shared expert outputs for first model 553 and second model 554, and second model-specific expert outputs.

For example, first model 553 can rank videos based on features, such as genre, length, and past user interactions, generating a prioritized list of content. First model 553 processes first model-specific expert outputs and shared expert outputs for first model 553 and generates intermediate outputs 603. In various embodiments, multi-level scoring module 547 checks whether intermediate outputs 603 are available in cache 548 before first model 553 processes first model-specific expert outputs and shared expert outputs for first model 553. If intermediate outputs 604 are available in cache 548, multi-level scoring module 547 retrieves intermediate outputs′ 604 from cache 548 and presents intermediate outputs′ 604 to second model 554. Second model 554 uses intermediate outputs 603 or intermediate outputs′ 604, along with specific expert outputs, to generate final output 602. For example, in an e-commerce setting, second model 554 can use intermediate outputs 603 related to user preferences and process intermediate outputs 603 along with expert outputs such as real-time data on stock availability and current promotions to finalize product recommendations.

### Hierarchical Models

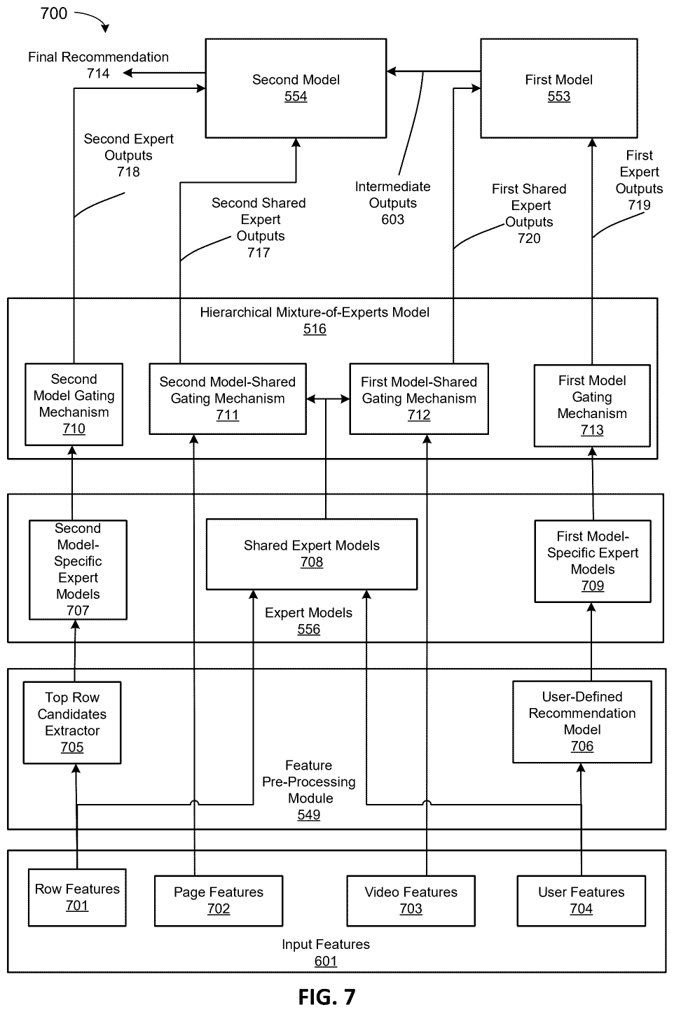

FIG. 7 is an example of the recommendation application 546 of FIG. 6, according to various embodiments. Recommendation system 700 is a personalized content recommendation system where input features 601 are processed and final recommendation 714 is generated. Recommendation system 700 includes, without limitation, input features 601, feature pre-processing module 549, expert models 556, hierarchical MoE model 516, first model 553, and second model 554. Input features 601, includes without limitation, row features 701, page features 702, video features 703, and user features 704. Feature pre-processing module 549 includes, without limitation, top row candidates extractor 705 and user-defined recommendation model 706. Expert models 556, includes without limitation, first model-specific expert models 709, shared expert models 708, and second model-specific expert models 707. Hierarchical MoE model 516 includes, without limitation, a first model gating mechanism 713, a first model-shared gating mechanism 712, a second model-shared gating mechanism 711, and a second model gating mechanism 710. Row features 701 are provided to top row candidates extractor 705 and shared expert models 708. Page features are provided to second model-shared gating mechanism 711. Video features 703 are provided to first model-shared gating mechanism 712. User features 704 are provided to shared expert models 708 and user-defined recommendation model 706.

As shown, input features 601 include, without limitation, row features 701, page features 702, video features 703, and user features 704. Row features 701 characterize the features of a row, often represented by the media content in a first predetermined number of positions (e.g., 5, 10, 15, etc.). Examples of row features 701 include row level unpersonalized play rate (PVR) features, which denote unpersonalized play rates of the first predetermined number of videos. The “row is novel” feature indicates whether the first predetermined number of media contents in a row are newly released. Another example of row features 701 is the “row days since last launch,” which tracks the number of days since the row was last launched or updated.

Page features 702 provide contextual information about the positioning and content similarity of rows within a page. Examples of page context features include, without limitation, the “row position” feature, which indicates the position of the row within the page, and the “number of genre above” feature, which counts the number of genre rows above the current row.

Video features 703 are specific attributes of the video content itself. Video features 703 includes, without limitation, metadata such as genre, director, cast, duration, and resolution of the video. For example, video features 703 can indicate whether a video is a blockbuster, a critically acclaimed documentary, a trending series, and/or the like. Video features 703 are useful for matching user preferences with appropriate content, because they directly relate to the content's inherent characteristics.

User features 704 include various contextual, behavioral, and historical attributes that characterize the interactions and preferences of individual users on the platform. Examples of user features 704 include membership features, which provide information related to the user's membership status, such as subscription tier (e.g., basic, standard, premium). The “one over days since last play” feature represents the inverse of the number of days since the user last played a video, indicating recent activity. User window features aggregate play statistics for the user over specific time windows, such as total play time or number of videos watched. Additionally, user features 704 include the total number of video impressions by the user across the platform, total row impressions, and the number of impressions for specific page types over different time windows.

Feature pre-processing module 549 pre-processes input features 601 and generates pre-processed input features. Feature pre-processing module 549 includes, without limitation, a top row candidates extractor 705 and a user defined recommendation (UDR) model 706. Top row candidates extractor 705 pre-processes row features 701 and extracts the most relevant row candidates based on row features 701. Top row candidates extractor 705 uses various metrics and attributes to select rows or groups of content that are likely to be most engaging for users. For example, top row candidates extractor 705 can analyze recent user interactions, such as watch history, search queries, and/or the like, to identify rows containing videos that match the user's interests. Additionally, top row candidates extractor 705 can consider factors such as the popularity of content, trending genres, user demographics, and/or the like to extract the most relevant rows. Top row candidates extractor 705 can also be customized to extract rows featuring newly released movies, trending TV series, or personalized recommendations based on the user's viewing patterns. In some embodiments, top row candidates extractor 705 is any suitable machine learning model, such as deep neural networks. In at least one embodiment, top row candidates extractor 705 selects a pre-set number of rows (e.g. top 100, 200, 300, etc. rows) to be processed by second model-specific expert models 707.

UDR model 706 is a machine learning model, such as a neural network and/or the like, which pre-processes user features 704. For example, UDR model 706 extracts features based on user preferences, such as favorite genres, preferred actors, and the type of content (e.g., documentaries or comedy shows), and/or the like. UDR model 706 can also include user-specified parameters such as desired content length, language preferences, content ratings, and/or the like.

Expert models 556 process pre-processed input features 606 and generate various expert outputs 605. Expert models 556 includes, without limitation, first model-specific expert models 709, shared expert models 708, and second model-specific expert models 707. First model-specific expert models 709 are machine learning models that process pre-processed input features 606 that are relevant to first model 553. In recommendation system 700, first model-specific expert models 709 process video content and user-video interactions. First model-specific expert models 709 can process detailed attributes such as video length, genre, and user engagement metrics, including watch time and user ratings and generate expert outputs 605 related to video content. For example, first model-specific expert models 709 can generate expert outputs 605 that identify patterns in how users interact with different types of videos, such as preferring certain genres at specific times of the day.

Shared expert models 708 are machine learning models that process row features 701 and user features 704 and generate expert outputs 605 associated with both the first model 553 and the second model 554. For example, shared expert models 708 process row features 701, such as unpersonalized play rates, as well as user features 704 such as membership status, recent activity, and overall viewing history. In various embodiments, shared expert models 708 unify features by selecting features relevant to both first model 553 and second model 554. Shared expert models generate expert outputs 605, such as user embeddings and content embeddings, which can include general user preferences and item characteristics.

Second model-specific expert models 707 are machine learning models that process features that are relevant to the second model 554. For example, in recommendation system 700, second model-specific expert models 707 generate expert outputs related to page context and user interactions and generate expert outputs, such as interaction scores and contextual embeddings. Interaction scores can quantify user engagement with different rows, while contextual embeddings can represent the user's current session behavior, including but not limited to device type and browsing patterns.

Hierarchical MoE model 516, includes various machine learning models, which processes input features 601 and mixes expert outputs 605 for first model 553 and second model 554. In various embodiments, hierarchical MoE model 516 includes various gating mechanisms, such as gating neural networks, that dynamically assign weights to the outputs of the expert models 556 based on input features 601. In various embodiments, hierarchical MoE model 516 dynamically adjusts the weights of various expert outputs 605 and manages the complexity of combining shared and task-specific expert outputs 605. For example, in recommendation system 700, hierarchical MoE model 516 mixes user viewing history, content metadata, and real-time interaction. In various embodiments, hierarchical MoE model 516 is a multi-layer neural network with an additional layer-wise gating approach, where the gating dynamically determines the contribution of shared and task-specific expert outputs 605 at each layer to manage conflicts among various expert outputs 605. In some examples, for each of expert outputs 605, a gating network calculates a weight or attention score, which is typically implemented using a feedforward network that outputs a weight ranging between 0 and 1. Expert outputs 605 are then multiplied by the respective gating weights and combined (e.g. summed) to form the final output for that layer. In various embodiments, hierarchical MoE model 516 manages conflicts between expert outputs 605 related to first model 553 and second model 554 by shared knowledge prioritization and task-specific knowledge prioritization. In shared knowledge prioritization, earlier layers of hierarchical MoE model 516 process shared input features 601 and the gates in early layers assign higher weights to shared expert outputs 605, which helps in learning general features such as user preferences or content attributes. In task-specific knowledge prioritization, each gate in the gating networks included in hierarchical MoE model 516 processes the outputs of first model-specific expert models 709 and second model-specific expert models 707. In some examples, the gating networks are small feedforward neural network designed to output attention scores or weights. The gating network processes the input features 601 to generate attention scores or weights for each of expert outputs 605. The scores reflect the relevance of each of the expert outputs 605 based on various factors, such as the current context and user behavior. Expert outputs 605 are then multiplied by the respective weights and attention scores and the weighted expert outputs 605 in the layer are then summed to form the combined layer output. As shown, hierarchical MoE model 516 includes, without limitation, a first model gating mechanism 713, first model-shared gating mechanism 712, second model-shared gating mechanism 711, and second model gating mechanism 710.

The first model gating mechanism 713 is a machine learning model, such as a neural network and/or the like, which processes expert outputs 605 related to user features 704 and generates first expert outputs 719. For example, first expert outputs 719 can include various expert outputs 605, such as user demographics, recent user activity, and overall viewing history. The first model gating mechanism 713 can assign higher weights to expert outputs 605 that capture user preferences and engagement metrics, enabling the generation of intermediate outputs 603, such as video ranks, by first model 553. The first model-shared gating mechanism 712 is a machine learning model, such as a neural network and/or the like, which processes video features 703 and mixes the expert outputs 605 from shared expert models 708 generating first shared expert outputs 720. In at least one embodiment, the first model-shared gating mechanism 712 mixes expert outputs by assigning weights. For example, first model-shared gating mechanism 712 processes combined video features 703, such as video length, genre, and quality, along with shared expert outputs 605 to generate first shared expert outputs 720, such as user preferences and content characteristics. The second model-shared gating mechanism 711 is a machine learning model, such as a neural network and/or the like, which processes page features 702 and mixes shared expert outputs 605 generating second shared expert outputs 717. In at least one embodiment, second model-shared gating mechanism 711 mixes shared expert outputs 605 by assigning weights. For example, second model-shared gating mechanism 711 mixes shared expert outputs 605 related to user demographics and overall viewing history, as well as row features such as row position and the number of genre rows above the current row to generate second shared expert outputs 717, such as contextual embeddings that capture the user's current browsing context and preferences, and interaction scores that quantify user engagement with different rows. The second model gating mechanism 710 is a machine learning model, such as a neural network and/or the like, which mixes expert outputs 605 related to row features 701 and generates second expert outputs 718. In various embodiments, second model gating mechanism 710 ensures that the second model 554 can generate final recommendations 714 based on real-time user behavior and specific row context on the page. For example, second model gating mechanism 710 processes expert outputs 605 related to features, such as the sequence of page views, clicks, and the specific context of rows on the page.

First model 553 is a machine learning model, such as a neural network, that processes first expert outputs 719 and first shared expert outputs 720 and generates intermediate outputs 603. In some examples, first model 553 is a row adapter (RA) model. The RA model ranks entities within groups, such as videos within a specific row in a streaming service. By processing user interaction data and video attributes, the RA model creates a prioritized list of content tailored to a user's preferences. The prioritization includes analyzing factors, such as video genre, user engagement metrics, and recent viewing history to determine the most relevant content. Intermediate outputs 603 from the RA model can include ranked lists of videos, relevance scores, and user-specific content embeddings. The RA model is described in more detail in conjunction with FIG. 8.

Second model 554 is a machine learning model, such as a neural network, that processes second expert outputs 718, second shared expert outputs 717, and intermediate outputs 603 and generates final recommendation 714. In some examples, second model 554 is an adaptive row ordering (ARO) model. The ARO model optimizes the presentation of content across rows on a page in a streaming service. By analyzing contextual information and user interaction patterns, the ARO model adjusts the order and prominence of rows to enhance user engagement. Final recommendation 714 from the ARO model can include reordered lists of rows, contextual relevance scores, and session-specific content recommendations. The ARO model ensures that the content layout is optimized for the user's current context, making the browsing experience more intuitive and engaging. The ARO model is described in more detail in conjunction with FIG. 9.

FIG. 8 illustrates a row adaptor model 800, which is an example of the first model 553 of FIG. 5, according to various embodiments. AR model 800 processes input features 601, which include, without limitation, user features 704, row features 701, and video features 703, and generates a conditional probability of streaming from a row 807. As shown, RA model 800 includes, without limitation, dense features 801, embedding vectors 802, a multi-layer perceptron 803, a features embedding vector 805, and a factorization machine 806. Multi-layer perceptron 803 includes, without limitation, a rectified linear unit 804A and a rectified linear unit 804B.

In various embodiments, RA model 800 is an architecture combining both wide and deep neural network components. For example, factorization machine 806 can use a wide neural network component and capture low-order interactions. Multi-layer perceptron 803 can use a deep neural network and captures high-order, non-linear feature interactions. The concatenation of wide and deep neural network components, such as multi-layer perceptron 803 and factorization machine 806, ensures that RA model 800 benefits from both low-order and high-order interactions, leading to more accurate and personalized recommendations. Factorization machine 806 is a predictive model, such as a collaborative filtering model, that is useful for dealing with high-dimensional and sparse data. Factorization machines extend the concept of matrix factorization, which is often used in collaborative filtering, by including interaction effects between variables and modeling relationships between features in a way that linear models cannot.

In operation, input features 601 are either transformed into embedding vectors 802 (e.g. categorical features) or used directly as dense features 801 (e.g. numerical features). Embedding vectors 802 and dense features 801 are concatenated to form the initial input vector h₀:

$${h}_{0} = concat ( {e}_{1} , {e}_{2} , … , {e}_{{M}^{′}} , {d}_{core} ) \qquad ( Equation 1 )$$

where concat is a concatenation function, et represents the embedding vectors 802, and d_{core} represents dense features 801. Multi-layer perceptron 803 includes a stack of fully connected layers that process h₀ to capture high-order, non-linear interactions using rectified linear unit 804A to generate h₁ as follows

$${h}_{1} = σ ( {W}_{1} {h}_{0} + {b}_{1} ) \qquad ( Equation 2 )$$

where W₁ is the weight matrix, b₁ is the bias vector, and σ is the activation function, such as the Rectified Linear Units (ReLUs) activation functions. ReLUs activation functions are used in neural networks to introduce nonlinearity into the model, enabling the model to learn complex patterns in the data. ReLUs are defined by the function

$$R e L U ( x ) = max ( 0 , x ) \qquad ( Equation 3 )$$

which means that for any input x, the output is x if x is positive, and 0 otherwise. Rectified linear unit 804B then processes h₁ as

$${h}_{2} = σ ( {W}_{2} {h}_{1} + {b}_{2} ) \qquad ( Equation 4 )$$

where W₂ is the weight matrix, b₂ is the bias vector, and σ is the activation function, such as the ReLUs activation functions. In some examples, factorization machine 806 is used to model interactions between each pair of features. In various embodiments, factorization machine 806 uses dot products to generate linear combinations of features and to capture pairwise interactions. Output of factorization machine 806, denoted as f^{m}_{core}, is concatenated with the last hidden layer output of multi-layer perceptron 803 to form the combined vector h_{f}:

$${h}_{f} = concat ( {h}_{2} , f {m}_{core} ) . \qquad ( Equation 5 )$$

In various embodiments, the combined vector h_{f} passes through one last hidden layer for final transformation

$$z = σ ( {W}_{f} {h}_{f} + {b}_{f} ) \qquad ( Equation 6 )$$

where W_{f} is the weight matrix and bf is the bias vector for the final transformation, and z is the content relevance scores 807. Content relevance scores 807 pertains to the relevance or suitability of content within each row, based on the user's preferences and interaction history. For example, content relevance scores 807 can include rankings or scores indicating the relevance or likelihood of user engagement with specific content within a row. Content relevance scores 807 can be a set of scores or probabilities associated with each piece of content within the row, determining how likely a user is to interact with or stream that content based on a user's past behavior and the content's attributes.

FIG. 9 illustrates an adaptive row ordering model 900, which is an example of the second model 554 of FIG. 5, according to various embodiments. ARO model 900 process input features 601, which includes, without limitation, user features 704, row features 701, and page features 702, and generates row layouts 910. As shown, ARO model 900 includes, without limitation, a core model 908 and a contextual model 912. Contextual model 912 includes, without limitation, context dense features 909, context embedding vectors 911, and a factorization machine 906B. Core model 908 includes, without limitation, a user's taste representation model 907, a multi-layer perceptron 903, core dense features 901, and core embedding vectors 902. User's taste representation model 907 includes, without limitation, a user's taste representation 905 and a factorization machine 906A. Multi-layer perceptron 903 includes, without limitation, a rectified linear unit 904A and a rectified linear unit 904B.

ARO model 900 is concerned with the arrangement or ordering of rows on the page. ARO model 900 uses the outputs from the RA model 800 among other inputs to optimize the presentation of multiple rows across a user interface. The output of the ARO model 900, row layouts 910, can include reordered lists of rows or decisions about which rows to display and in what order. Row layouts 910 helps in optimizing the layout of the entire page or interface to improve user engagement. In various embodiments, ARO model 900 uses wide and deep learning architectures. A wide learning architecture is a linear component that is useful in analyzing interactions to capture specific patterns that frequently occur in the data. For example, factorization machines 906A and 906B can use a wide learning architecture to model the first and second order interactions among various features. A deep learning architecture, such as multi-layer perceptron 903, is a neural network component useful at generalizing from both dense and sparse feature representations, learning abstract relationships that can be applied to new, and unseen data. For example, multi-layer perceptron 903 can be a two-layer multi-layer perceptron with layer sizes of 1024 and 64 neurons. Multi-layer perceptron 903 analyzes patterns and interactions in core dense features 901 and core embedding vectors 902 and generates higher-level features related to the user for user's taste representation 905. In various embodiments, the computations of core model 908 are shared across multiple row positions, thereby reducing redundancy and avoiding repeated calculations. The architecture of ARO model 900 as shown in FIG. 9 allows the context-specific computations, carried out by contextual model 912, are performed multiple times, adapting to changes in page context included in page features 702 without re-evaluating user features 704 and row features 701.

Core model 908 processes user features 704 and row features 701 and generates a row representation consistent across different row positions on a page. Core dense features 901 includes but is not limited to aggregated and transformed data from user features 704 and row features 701, such as user activity levels, engagement patterns and/or the like. In various embodiments, core dense features 901 are stable and long-term attributes related to the user (e.g., past viewing habits, genre preferences). Core dense features 901 do not change frequently and are used to create a foundational representation of the user's tastes. Core embedding vectors 902 include but is not limited to the transformed row features 701 and user features 704 into lower-dimensional spaces.

Multi-layer perceptron 903 is a machine learning model, such as a neural network, which processes core dense features 901 and core embedding vectors 902. Multi-layer perceptron 903 includes, without limitation, a rectified linear unit 904A and a rectified linear unit 904B. Rectified linear units 904A and 904B include ReLUs activation functions described in Equation 3. Rectified linear units 904A and 904B included in multi-layer perceptron 903 are used to process core dense features 901 and core embedding vectors 902. Multi-layer perceptron 903 can include multiple layers of neurons, each followed by a ReLU activation function to introduce non-linearity. For example, core dense features 901 can include specific numeric attributes of user features 704 and row features 701, while core embedding vectors 902 can include high-dimensional representations of row features 701 and user features 704. As the data passes through the layers of the multi-layer perceptron 903, rectified linear units 904A and 904B apply the ReLU function to ensure that the network can learn and represent non-linear relationships within the core dense features 901 and core embedding vectors 902.

User's taste representation model 907 is a machine learning model, such as a neural network, that processes the outputs of multi-layer perceptron 903 and core embedding vectors 902 and generates a row representation consistent across different row positions on the page. In various embodiments, user's taste representation model 907 is a dynamic embedding that combines stable long-term preferences with session-specific/page-context adjustments to provide personalized and contextually relevant recommendations. In at least one embodiment, core model 908 processes core dense features 901 using deep and wide neural network layers to compute the user's taste representation 905. In some examples, user's taste representation 905 captures the user's preferences and is designed to be reused across different sessions and contexts. In some embodiments, user's taste representation 905 is cached to avoid re-computation and reused whenever core dense features 901 remain unchanged.

Factorization machine 906A decomposes core embedding vectors 902 into latent factors, which are then used to capture interactions between the features. The interactions are, for example, represented as dot products of the latent factor vectors. User's taste representation 905 is a machine learning model, such as a neural network, that processes outputs of multi-layer perceptron 903 and models behaviors of individual users based on the interactions with the media content on the platform. For example, if a user frequently watches action media content and rates action media contents highly, user's taste representation 905 can emphasize the preference in action media content. In various embodiments, user's taste representation 905 aligns the user's historical interactions with the available media content, ensuring that the outputs of user's taste representation model 907 are based on each user's unique tastes.

Contextual model 912 is a machine learning model, such as a neural network, which processes pages features 702 and the outputs of core model 908 and generates row layouts 910. In various embodiments, contextual model 912 refines the user's taste representation 905 using context dense features 909. In some examples, contextual model 912 adjusts the cached user's taste representation 905 to better match the specific context of the current session or page, ensuring that recommendations are relevant and timely. Context dense features 909 include, without limitation, processed attributes of page features 702, such as row position within the page and the number of genre rows above the current row. In some embodiments, context dense features 909 are dynamic attributes related to the specific context of the page or session (e.g., current session interactions and page-specific elements). Context dense features 909 are more volatile than core dense features 901 and can change frequently based on user interactions and the context of the current page. Context embedding vectors 911 receive page features 702 and transform page features 702 into lower-dimensional representations. The transformation allows for more computationally efficient processing and integration within machine learning models, such as factorization machine 906B. For example, context embedding vectors 911 can represent the relative importance of a row's position or the influence of the number of genre rows above that row. Factorization machine 906B is a predictive model, such as a collaborative filtering model, that processes the interactions between the outputs of core model 908 and contextual features included in context dense features 909 and context embedding vectors 911 and generates row layouts 910. Row layouts 910 can include the context-specific arrangement of rows, accounting for factors such as the rows' location on the page and the number of genre rows above that row.

### Training a Hierarchical Model

FIG. 10 illustrates a more detailed illustration of the model trainer 515 of FIG. 5, according to various embodiments. As shown, model trainer 515 includes, without limitation, a parameter freezing module 1001, a loss calculation module 1002, and a backpropagation module 1003. Model trainer 515 uses training data 557 to train expert models 556, hierarchical MoE model 516, first model 553, and second model 554. Training data 557 includes, without limitation, a first training data 1010, a first validation data 1020, a second training data 1011, and a second validation data 1021. First training data 1010, first validation data 1020, second training data 1011, and second validation data 1021 include various input features 601 and the corresponding final outputs 602 (e.g. ground truths). In some examples, such as training recommendation system 700, training data 557 includes the logged pages. The logged pages include positive and negative training features for second model 554. For example, a media content that yields a qualified play is labeled as positive, while all other media content from both positive and negative rows are labeled as negative. In some embodiments, two additional columns are introduced in training features to specify whether the label is positive or negative for first model 553 and second model 554, along with two more columns to facilitate data filtering for training and evaluation purposes for first model 553 and second model 554. In at least one embodiment, for the subsampling mechanism, all positive training features are retained and the negative training features are downsampled, utilizing only subsets or percentages of the negative training features (e.g., 15%, 30%, 50%, etc.).

Model trainer 515 trains expert models 556, hierarchical MoE model 516, first model 553, and second model 554 in several epochs which include forward and backward passes. To begin, the parameters of expert models 556, hierarchical MoE model 516, first model 553, and second model 554 are initialized, for example, by random selection. In the forward pass, first training features included in first training data 1010 are provided to expert models 556 and hierarchical MoE model 516, which also receives expert outputs 605. Hierarchical MoE model 516 uses first training features included in first training data 1010 to mix various expert outputs 605 and provides the mixed expert outputs to first model 553 and second model 554. First model 553 processes the mixed expert outputs and generates intermediate outputs 603 which are provided to second model 554. Second model 554 processes the mixed expert outputs and intermediate outputs to generate final output 602. Loss calculation module 1002 compares final output 602 with final output included in first training data 1010 and calculates a loss. In the backward pass, backpropagation module 1003 computes the corresponding gradients of the loss and propagates the gradients through expert models 556, hierarchical MoE model 516, first model 553, and second model 554 to update the parameters. In various embodiments, backpropagation module 1003 updates parameters using gradient descent techniques, which include regularization methods, such as dropout or L2 regularization to prevent overfitting.

Parameter freezing module 1001 monitors first model 553 and determines whether to freeze the parameters of first model 553 based on various criteria including but not limited to convergence performance, cross-task performance, and validation performance. Freezing criteria based on convergence performance includes but is not limited to plateauing performance and plateauing loss. In some embodiments, parameter freezing module 1001 determines to freeze first model 553 when various performance metrics (e.g., area under the curve, training loss, etc.) have plateaued over several training epochs, indicating that first model 553 has been trained. When the area under the curve metric plateaus, the ability to distinguish between classes has reached an optimal point. In some embodiments, parameter freezing module 1001 determines to freeze the parameters of first model 553 when the training loss calculated by loss calculation module 1002 for the first model 553 has plateaued, showing that further training does not significantly reduce the loss. In some examples, parameter freezing module 1001 determines to freeze the parameters of first model 553 when the training loss plateaus and shows minimal improvement over several epochs (e.g. when the improvement in training loss falls below a predefined threshold, such as less than 0.1%). In some embodiments, parameter freezing module 1001 freezes the parameters of first model 553 based on cross-task performance. For example, parameter freezing module 1001 checks whether freezing parameters of first model 553 leads to the performance of second model 554 and hierarchical MoE model 516 being stable or improving. In some embodiments, parameter freezing module 1001 freezes the parameters of first model 553 based on validation performance. For example, parameter freezing module 1001 freezes the parameters of first model 553 when the validation accuracy for the first model 553 remains constant across multiple validations sets included in first validation data 1020, such as when the validation loss reaches a minimum and remains stable, indicating that further training does not reduce the loss.

Once parameter freezing module 1001 determines to freeze the parameters of the first model 553, parameter freezing module 1001 freezes the parameters of first model 553. Model trainer 515 then uses second training data 1011 to train expert models 556, hierarchical MoE model 516, and second model 554. In the forward pass, second training features included in second training data 1011 are provided to expert models 556 and hierarchical MoE model 516, which also receives expert outputs 605. Hierarchical MoE model 516 uses second training features included in second training data 1011 to mix various expert outputs and provides the mixed expert outputs to first model 553 with frozen parameters and second model 554. First model 553 with frozen parameters processes the mixed expert outputs and generates intermediate outputs 603 which are provided to second model 554. Second model 554 processes the mixed expert outputs and intermediate outputs 603 to generate final output 602. Loss calculation module 1002 compares final output 602 with final output included in second training data 1011 and calculates a loss. In some examples, loss calculation module 1002 calculates the loss based on the difference between the predicted and actual streaming probabilities for rows. In the backward pass, backpropagation module 1003 calculates the corresponding gradients of the loss and propagates the gradients through expert models 556, hierarchical MoE model 516, and second model 554 to update the parameters. In various embodiments, backpropagation module 1003 updates parameters using gradient descent techniques, which include regularization methods, such as dropout or L2 regularization to prevent overfitting. The training of hierarchical MoE model 516, expert models 556, and second model 554 continues until a stopping criterion is met, such as achieving a specific level of validation accuracy using second validation data 1021, reaching a plateau in the training loss, or completing a predefined number of training epochs.

In various embodiments, once model trainer 515 finishes training hierarchical MoE model 516, expert models 556, first model 553, and second model 554, model trainer 515 stores hierarchical MoE model 516, expert models 556, first model 553 and second model 554 in data store 520. In at least one embodiment, model trainer 515 also creates a second model′ 1030, which is a replica of the trained second model 554 having a same structure and parameters as trained second model 554. In some examples, when second model 554 is a neural network, second model′ 1102 share the same layers and/or parameters, so the parameters are kept in sync with second model 554.

### Multi-Level Scoring

FIG. 11 illustrates a more detailed illustration of the multi-level scoring module 547 of FIG. 5, according to various embodiments. As shown, multi-level scoring module 547 includes, without limitation, an intermediate output caching module 1101 and a cache lookup module 1110. Multi-level scoring module 547 interacts with cache 548 and first model 553 to cache new intermediate outputs 603 and generates intermediate outputs′ 604 if corresponding intermediate outputs 603 have been generated before.

During inference, first model 553 receives first shared expert outputs 720 and first expert outputs 719. Cache lookup module 1110 looks up intermediate outputs 603 in cache 548. In various embodiments, cache 548 includes an indexed look-up table, where unique keys correspond to specific input patterns. Each unique key maps to the corresponding intermediate outputs 603. When an input pattern matches a key in the lookup table, cache lookup module 1110 retrieves the corresponding intermediate outputs 603 from cache 548. Multi-level scoring module 547 generates intermediate outputs′ 604 Second model′ 1102 then processes intermediate outputs′ 604, second shared expert outputs 717, and second expert outputs 718 and generates final output′ 1104. If cache lookup module 1110 does not find intermediate outputs 603 in cache 548, first model 553 processes first expert outputs 719 and first shared expert outputs 720 and generates intermediate outputs 603, which are provided to multi-level scoring module 547 and second model 554. Intermediate output caching module 1101 caches intermediate outputs 603 in cache 548 for future use. In some embodiments, intermediate output caching module 1101 uses a keyed entry for caching. In some examples, intermediate output caching module 1101 generates the keyed entry by hashing the specific input pattern corresponding to first expert outputs 719 and first shared expert outputs 720, ensuring a unique and retrievable identifier for each set of intermediate outputs 603. When the same input pattern is received, cache lookup module 1110 retrieves the corresponding intermediate outputs 603 from cache 548. Second model 554 processes second shared expert outputs 717, second expert outputs 718, and intermediate outputs 603 and generates final output 602.

Although the operation of multi-level scoring module 547 is described herein with respect to intermediate outputs 603 generated by first model 553 in FIG. 11, persons skilled in the art will understand that other arrangements of components is also possible. For example, first model 553 can be replaced by UDR model 706, first model-specific expert models 709, shared expert models 708 and first model gating mechanism 713. First expert outputs 719 and first shared expert outputs 720 can then be replaced by user features 704, row features 701, video features 703, and various pre-processed input features 606 as well as expert outputs 605. Second model 554 can be replaced by first model-shared gating mechanism 712 and second model-shared gating mechanism 711 and intermediate output caching module 1101 caches first shared expert outputs 720 and second shared expert outputs 717 in cache 548. In some embodiments, intermediate output caching module 1101 uses a keyed entry for caching first shared expert outputs 720 and second shared expert outputs 717 in cache 548. Intermediate output caching module 1101 caches first shared expert outputs 720 and second shared expert outputs 717 by hashing the specific input pattern corresponding to the first expert outputs 719 and first shared expert outputs 720. Each unique key corresponds to a set of intermediate outputs 603, allowing for retrieval. When the same input pattern is received again, the cache lookup module 1110 retrieves the corresponding intermediate outputs 603 from cache 548, bypassing the need for redundant computations.

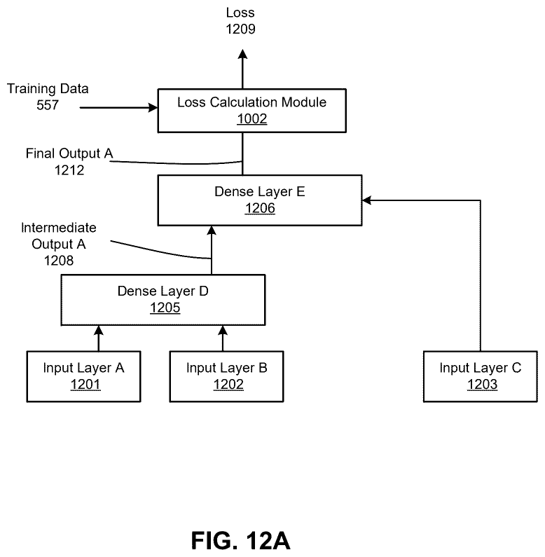

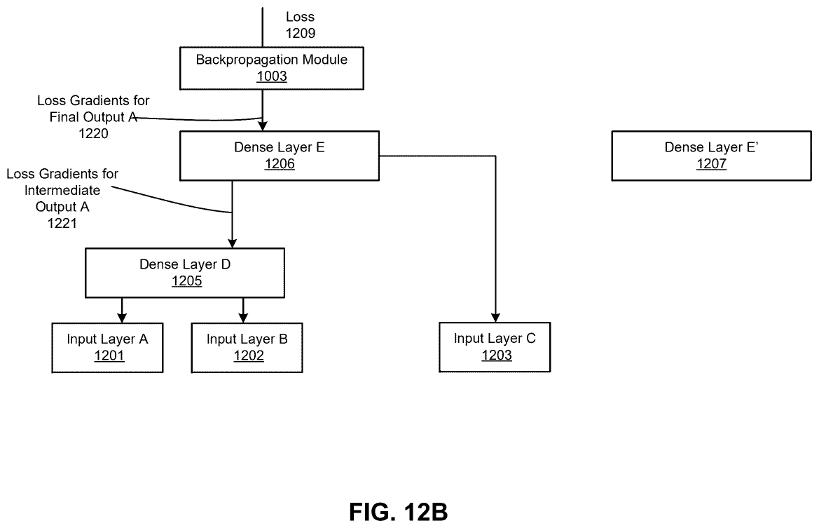

FIG. 12A illustrates an example of the model trainer 515 of FIG. 5 during the forward pass of training, according to various embodiments. In the context of FIG. 7, dense layer D 1205, input layer A 1201, and input layer B 1202 can correspond to first model 553, such as RA model 800, or UDR model 706, first model-specific expert models 709, shared expert models 708, first model gating mechanism 713, and first model-shared gating mechanism 712. Dense layer E 1206 can correspond to second model 554, such as ARO model 900, or top row candidates extractor 705, second model-specific expert models 707, shared expert models 708, second model gating mechanism 710, and second model-shared gating mechanism 711. Other arrangements of the input layer A 1201, input layer B 1202, dense layer D 1205 and dense layer E 1206 are also possible. For example, dense layer D 1205, input layer A 1201, input layer B 1202 can correspond to either expert models 556 or top row candidates extractor 705. Input layer A 1201 and input layer B 1202 can represent various input features 601, such as user features 704 and row features 701 processed by expert models 556. Expert models 556 process various input features 601 to generate intermediate outputs A 1208. Intermediate output A 1208 can correspond to the outputs of the expert models 556. Dense layer E 1206 can represent the combination and further processing of features by various gating mechanisms included in hierarchical MoE model 516. Input layer C 1203 can represent additional input features 601, such as page features 702 or video features 703.

As shown, during the forward pass of training, model trainer 515 initializes the parameters of dense layer E 1206, input layer A 1201, input layer B 1202, input layer C 1203, and dense layer D 1205, for example, by random selection. Training data 557 is processed by input layer A 1201, input layer B 1202, and input layer C 1203. The outputs of input layer A 1201 and input layer B 1202 are received by dense layer D 1205. Dense layer D 1205 generates intermediate output A 1208 which is then processed along with additional features from input layer C 1203 in dense layer E 1206 to generate final output A 1212. Loss calculation module 1002 compares final output A 1212 with final output included in training data 557 and calculates loss 1209.

In various embodiments, parameter freezing module 1001 determines to freeze dense layer D 1205 using various criteria on loss 1209. In some examples, parameter freezing module 1001 determines to freeze dense layer D 1205 when loss 1209 have plateaued over several training epochs, indicating that dense layer D 1205 has been trained. In some embodiments, parameter freezing module 1001 freezes the parameters of dense layer D 1205 based on cross-task performance. For example, parameter freezing module 1001 checks whether freezing parameters of dense layer D 1205 leads to loss 1209 being stable or improving.

FIG. 12B illustrates an example of the model trainer 515 of FIG. 5 during the backward pass of training, according to various embodiments. As shown, during backward pass, backpropagation module 1003 receives loss 1209 and generates loss gradients which are propagated. Backpropagation module 1003 module computes the gradients of loss 1209 with respect to the parameters of the neural network layers, facilitating the process of updating the weights to minimize loss 1209. Backpropagation Module 1003 propagates loss gradients for final output A 1220 to dense layer E 1206 and backpropagation module 1003 updates the parameters to reduce loss 1209. Similar to dense layer E 1206, backpropagation module 1003 propagates loss gradients for intermediate output A 1221 to dense layer D 1205 and backpropagation module 1003 updates the parameters of dense layer D 1205 to generate intermediate output A 1208 that contribute to more accurate final output A 1212 and smaller values of loss 1209. Similar to dense layer E 1206 and dense layer D 1205, backpropagation module 1003 updates propagates the gradients to input layer A 1201, input layer B 1202, and input layer C 1203 and updates the parameters of input layer A 1201, input layer B 1202, and input layer C 1203 such that loss 1209 is minimized.

In various embodiments, model trainer 515 updates the parameters of dense layer E 1206, dense layer D 1205, input layer A 1201, input layer B 1202, and input layer C 1203 in iterative forward pass and backward pass until a stopping criterion is met, such as reaching a plateau in loss 1209 or completing a predefined number of training epochs. Once model trainer 515 trains dense layer E 1206, dense layer D 1205, input layer A 1201, input layer B 1202, and input layer C 1203, model trainer 515 stores dense layer E 1206, dense layer D 1205, input layer A 1201, input layer B 1202, and input layer C 1203 in data store 520. In some embodiments, model trainer 515 creates dense layer E′ 1207 as a replica of dense layer E 1206, with the same parameters and/or layers. In the context of FIG. 11, intermediate output A′ 1211 is an example of intermediate outputs′ 604, which can be the cached outputs of dense layer D 1205. Dense layer E′ 1207 is an example of second model′ 1102.

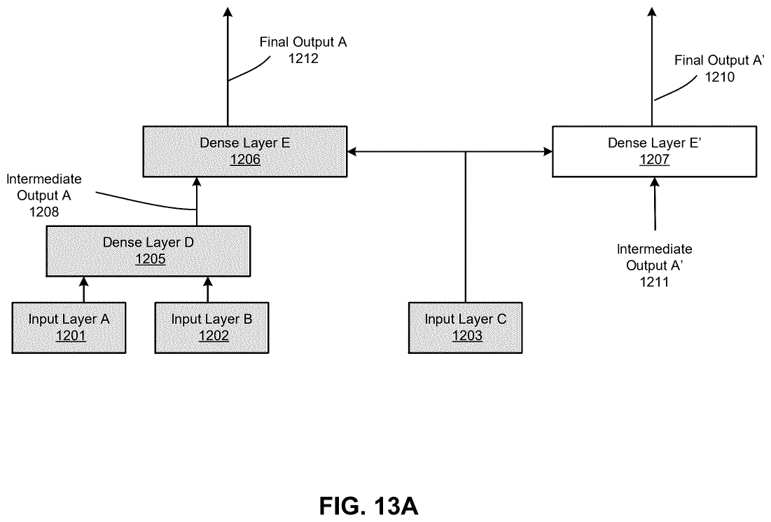

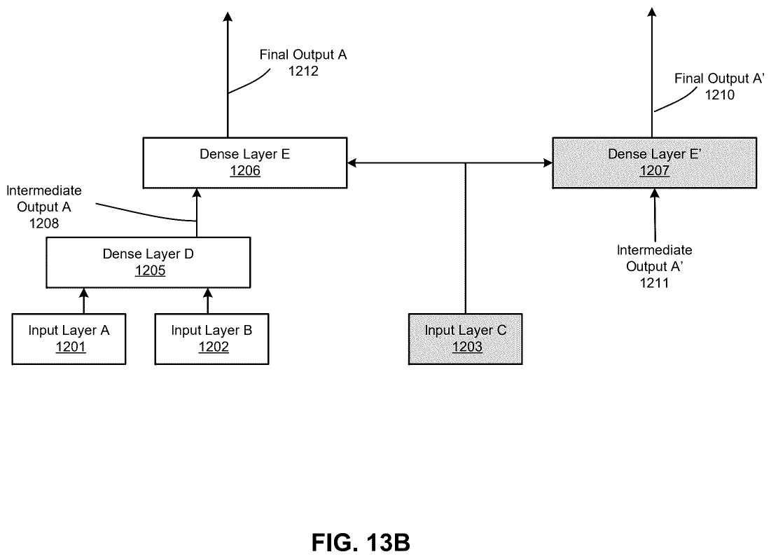

FIG. 13A illustrates an example of the multi-level scoring module 547 of FIG. 5 without using cached intermediate outputs 603 during inference, according to various embodiments. The grey modules represent the active modules and the while modules represent the inactive modules.

As shown, during inference, the outputs of input layer A 1201 and input layer B 1202 are received by dense layer D 1205. Cache lookup module 1110 checks if intermediate output A 1208 is available in cache 548 by using an indexed lookup table. Each entry in the lookup table corresponds to a unique key derived from the specific input pattern processed by dense layer D 1205. Cache lookup module 1110 searches the lookup table to determine if a matching entry exists. If a match is found, the corresponding intermediate output A 1208 is retrieved from cache 548. If intermediate output A 1201 is not available in cache 548, dense layer D 1205 processes the outputs of input layer A 1201 and input layer B 1202 and generates intermediate output A 1208. Intermediate output caching module 1101 caches intermediate output A 1208 for future use by storing intermediate output A 1208 in cache 548 with a unique key generated from input patterns. Intermediate output caching module 1101 generates a key based on the specific input pattern processed by dense layer D 1205 and uses the key to generate an indexed entry in cache 548. Intermediate output caching module 1101 stores intermediate output A 1208, along with the corresponding key, in cache 548. Intermediate output A 1208 is then processed along with additional features from input layer C 1203 in dense layer E 1206 to generate final output A 1212.

FIG. 13B illustrates an example of multi-level scoring module 547 of FIG. 5 while using cached intermediate outputs 603 during inference, according to various embodiments. As shown, during inference, the outputs of input layer A 1201 and input layer B 1202 are received by dense layer D 1205. Cache lookup module 1110 checks if intermediate output A 1208 is available in cache 548. In some embodiments, cache 548 hashes the specific input patterns from input layer A 1201 and input layer B 1202 to determine whether the hashed input patterns correspond to a key in an entry in cache 548. If the hashed input patterns correspond to the key of an entry, the intermediate output A 1208, cache lookup module 1110 retrieves intermediate output A 1208 from the entry. If intermediate output A 1201 is available in cache 548, multi-level scoring module 547 retrieves intermediate output A′ 1211 from cache 548 and provides intermediate output A′ 1211 to dense layer E′ 1207, which is a replica of dense layer E 1206. Dense layer E′ 1207 processes intermediate output A′ 1211 and the output of input layer C 1203 and generates final output′ A 1210. For example, when a combination of first expert outputs 719 and first shared expert outputs 720 are presented that have been processed by first model 553 before and cached by intermediate output caching module 1101, multi-level scoring module 547 retrieves the cached intermediate output A′ 1211 from cache 548 and provides intermediate output A′ 1211 to second model′ 1102, such as ARO model 900, using dense layer E′ 1207 without having to repeat the inferencing needed to recalculate the intermediate output A 1208 using first model 553.

FIG. 14 sets forth a flow diagram of method steps for processing input features 601 and generating final output 602, according to various embodiments. Although the method steps are described in conjunction with the systems of FIGS. 6-9 and 14, persons skilled in the art will understand that any system configured to perform the method steps in any order falls within the scope of the present disclosure.

The method 1400 begins with step 1410, where recommendation application 546 receives input features 601. In the context of recommendation system 700, input features 601 includes, without limitation, row features 701, page features 702, video features 703, and user features 704.

At step 1420, feature pre-processing module 549 pre-processes input features 601 and generate pre-processed input features 606. In various embodiments, feature pre-processing module 549 processes input features 601 for multiple tasks, including but not limited to data cleaning, normalization, encoding of categorical variables, and feature extraction. For example, in a content streaming platform, feature pre-processing module 549 can process input features 601 such as user interaction logs, video metadata, and session information, transforming input features 601 into pre-processed input features 606 suitable for expert models 556. In some embodiments, the pre-processing ensures that input features 601 are standardized and appropriately scaled, thereby improving the performance and accuracy of expert models 556. Feature pre-processing module 549 also addresses issues related to missing input features, applies transformations such as log scaling for skewed data distributions, and generates new input features 601 using techniques, such as polynomial combinations or interaction terms. When the number of input features 601 is extensive, feature pre-processing module 549 can extract the most important input features 601 to streamline processing. For example, feature pre-processing module 549 can identify and prioritize features such as a user's top watch list or most frequently interacted with content. In recommendation system 700, feature pre-processing module 549 can include top row candidates extractor 705 and UDR model 706. Top row candidates extractor 705 pre-processes row features 701 to identify the most relevant row candidates. Top row candidates extractor 705 selects rows likely to engage users by analyzing recent user interactions, such as watch history and search queries. Top row candidates extractor 705 also considers content popularity, trending genres, and user demographics to determine the most relevant rows. Additionally, top row candidates extractor 705 can highlight rows featuring newly released movies, trending TV series, or personalized recommendations based on viewing habits. In some embodiments, top row candidates extractor 705 selects a preset number of rows. UDR model 706 extracts features based on user preferences, such as favorite genres, preferred actors, and content types, such as documentaries or comedy shows. UDR model 706 also includes user-specified parameters, such as desired content length, language preferences, and content ratings.

At step 1430, expert models 556 process pre-processed input features 606 and input features 601 and generate expert outputs 605. The generated expert outputs 605 can include user embeddings, content embeddings, interaction scores, feature importance scores, contextual embeddings, engagement predictions, sentiment scores, and/or the like. For example, in a media recommendation system, expert outputs 605 can include user embeddings that capture a user's taste in media content items, content embeddings that summarize the attributes of various films, and interaction scores that reflect past viewing behaviors. In recommendation system 700, expert models 556 include, without limitation, first model-specific expert models 709, shared expert models 708, and second model-specific expert models 707. First model-specific expert models 709 generate expert outputs related to media content, such as media length, genre, and user engagement metrics, such as watch time and ratings. First model-specific expert models 709 can identify user preferences for specific types of media. Shared expert models 708 generate expert outputs 605 related to both row features 701 and user features 704. Shared expert models 708 generate expert outputs 605, such as unpersonalized play rates, user membership status, recent activity, and overall viewing history, which help unify features relevant to both first model 553 and second model 554. Second model-specific expert models 707 generate expert outputs 605 related to page context and user interactions. For example, second model-specific expert models 707 generate interaction scores, which measure user engagement with different rows, and contextual embeddings, which represent the user's session behavior, including device type and browsing patterns.

At step 1440, hierarchical MoE model 516 processes input features 601 and mixes expert outputs 605 based on gating weights and generates mixed expert outputs. In various embodiments, hierarchical MoE model 516 uses several gating mechanisms, to dynamically assign weights to expert outputs 605 based on input features 601. In some examples, the gating mechanisms allocate weights to both second model-specific and shared expert models 556 using input features 601, such as user data, row features, and page context. The selection and placement of rows include determining which rows of content to display and the order of rows on the page Similar to second model-specific and shared expert models 556, hierarchical MoE model 516 mixes expert outputs 605 from first model-specific and shared expert models 556 using weights based on input features 601, such as user data, row attributes, and video content. In recommendation system 700, hierarchical MoE model 516 includes various machine learning models that process input features 601 and mix expert outputs 605 for first model 553 and second model 554 to generate final recommendation 714. In some examples, hierarchical MoE model 516 adjusts the weights of expert outputs 605 in real-time. In at least one embodiment, hierarchical MoE model 516 manages conflicts between expert outputs 605 related to first model 553 and second model 554 by prioritizing shared knowledge and task-specific knowledge. In shared knowledge prioritization, earlier layers of hierarchical MoE model 516 process shared input features 601, with gates assigning higher weights to shared expert outputs 605 to learn general features, such as user preferences or content attributes. In task-specific knowledge prioritization, each gate in the gating networks processes the outputs of first model-specific expert models 709 and second model-specific expert models 707. In recommendation system 700, hierarchical MoE model 516 includes, without limitation, a first model gating mechanism 713, first model-shared gating mechanism 712, second model-shared gating mechanism 711, and second model gating mechanism 710. The first model gating mechanism 713 processes expert outputs 605 related to user features 704 and generates first expert outputs 719. The first model gating mechanism 713 assigns higher weights to expert outputs 605 that capture user preferences and engagement metrics. The first model-shared gating mechanism 712 processes video features 703 and combines expert outputs 605 from shared expert models 708 to generate first shared expert outputs 720. The second model-shared gating mechanism 711 processes page features 702 and mixes shared expert outputs 605 to generate second shared expert outputs 717. The second model gating mechanism 710 processes expert outputs 605 related to row features 701 and generates second expert outputs 718. In various embodiments, second model gating mechanism 710 ensures that second model 554 can generate final recommendations 714 based on real-time user behavior and specific row context on the page. Hierarchical MoE model 516 dynamically determines the contribution of shared and task-specific expert outputs 605 at each layer to resolve conflicts among various expert outputs 605. For each expert output 605, a gating network calculates a weight or attention score using a feedforward network that outputs a weight ranging between 0 and 1. Expert outputs 605 are then multiplied by the respective gating weights and combined (e.g., summed) to form the final output for that layer.

At step 1450, first model 553 processes mixed expert outputs and intermediate outputs 603. In various embodiments, first model 553 ranks entities within groups of entities based on various input features 601. First model 553 processes mixed expert outputs derived from user interactions, item attributes, contextual information, and other relevant data to generate intermediate outputs 603, such as user preferences and content relevance. In various embodiments, first model 553 uses various machine learning techniques, such as deep neural networks, to learn patterns and relationships within the data. Intermediate outputs 603 generated by first model 553 include refined representations of user preferences. By accurately ranking entities, first model 553 ensures that the most relevant and appealing items are considered by second model 554. In recommendation system 700, first model 553 processes first expert outputs 719 and first shared expert outputs 720 to generate intermediate outputs 603. In some examples, first model 553 is RA model 800.

At step 1460, second model 554 processes intermediate outputs 603 and mixed expert outputs and generate final output 602. In some examples, first model 553 uses contextual information and user interaction data to finalize final output 602 that are most likely to engage the user. In some embodiments, second model 554 uses various machine learning techniques, including but not limited to attention mechanisms, to process mixed expert outputs and intermediate outputs 603, generating final output 602, such as a recommendation, tailored to the user's immediate context. In recommendation system 700, second model 554 processes second expert outputs 718, second shared expert outputs 717, and intermediate outputs 603 to generate final recommendation 714. In some examples, second model 554 is ARO model 900.

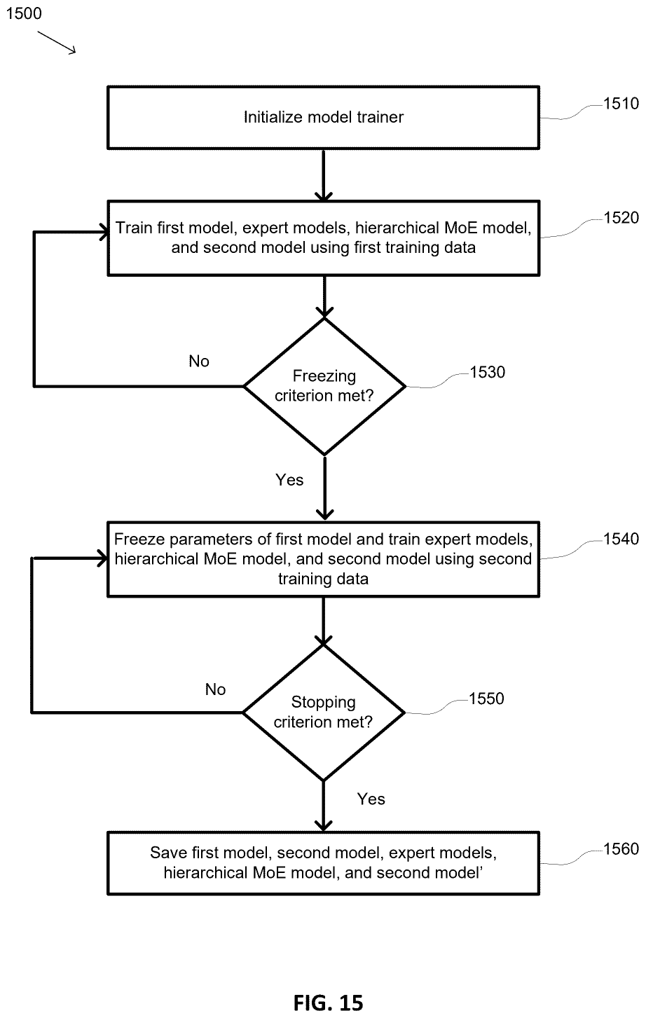

FIG. 15 sets forth a flow diagram of method steps for training a hierarchical model, according to various embodiments. For example, the hierarchical model could include the first model 553 and the second model 554. Although the method steps are described in conjunction with the systems of FIGS. 10, 12A, 12B, and FIG. 15, persons skilled in the art will understand that any system configured to perform the method steps in any order falls within the scope of the present disclosure.

The method 1500 begins with step 1510, where model trainer 515 is initialized. In various embodiments, the parameters of expert models 556, hierarchical MoE model 516, first model 553, and second model 554 are initialized, for example, by random selection. The initialization process includes setting up the environment for training, which includes loading training data 557. Training data 557 includes, without limitation, first training data 1010, first validation data 1020, second training data 1011, and second validation data 1021. First training data 1010, first validation data 1020, second training data 1011, and second validation data 1021 include various input features 601 and the corresponding final outputs 602 (e.g., ground truths). For example, in the context of training recommendation system 700, training data 557 includes logged pages containing both positive and negative training features for second model 554. In some embodiments, a subsampling mechanism is used where all positive training features are retained, and the negative training features are downsampled, using only a percentage of the negatives. Once the initialization is complete, including the setup of hyperparameters such as learning rate, batch size, and the number of epochs, model trainer 515 is ready to begin the training process in the subsequent steps.

At step 1520, model trainer 515 trains first model 553, expert models 556, hierarchical MoE model 516, and second model 554 using first training data 1010. Model trainer 515 trains expert models 556, hierarchical MoE model 516, first model 553, and second model 554 over several epochs, which include forward and backward passes. During the forward pass, first training features from first training data 1010 are provided to expert models 556 and hierarchical MoE model 516, which also receives expert outputs 605. Hierarchical MoE model 516 uses the first training features to mix various expert outputs and provides the mixed expert outputs to first model 553 and second model 554. First model 553 processes the mixed expert outputs and generates intermediate outputs 603, which are then provided to second model 554. Second model 554 processes both the mixed expert outputs and the intermediate outputs 603 to generate final output 602. The loss calculation module 1002 compares final output 602 with the ground truth final output included in first training data 1010 and calculates the loss. During the backward pass, backpropagation module 1003 calculates the corresponding gradients for the loss and propagates the gradients through expert models 556, hierarchical MoE model 516, first model 553, and second model 554 to update the parameters. In various embodiments, backpropagation module 1003 updates parameters using gradient descent techniques, which can include regularization methods, such as dropout or L2 regularization to prevent overfitting.

At step 1530, parameter freezing module 1001 checks whether a freezing criterion is met. In various embodiments, parameter freezing module 1001 monitors first model 553 and determines whether to freeze the parameters of first model 553 based on various criteria including but not limited to convergence performance, cross-task performance, and validation performance. Freezing criteria based on convergence performance includes but is not limited to plateauing performance and plateauing loss. In some embodiments, parameter freezing module 1001 determines to freeze first model 553 when various convergence performance metrics (e.g., area under the curve, training loss, etc.) have plateaued over several training epochs, indicating that first model 553 has been trained. In some embodiments, parameter freezing module 1001 determines to freeze the parameters of first model 553 when the training loss calculated by loss calculation module 1002 for the first model 553 has plateaued. In some examples, parameter freezing module 1001 determines to freeze the parameters of first model 553 when the training loss plateaus and shows minimal improvement over several training epochs. In some embodiments, parameter freezing module 1001 determines to freeze the parameters of first model 553 based on cross-task performance. For example, parameter freezing module 1001 checks whether freezing parameters of first model 553 leads to the performance of second model 554, expert models 556, and hierarchical MoE model 516 being stable or improving. In some embodiments, parameter freezing module 1001 determines to freeze the parameters of first model 553 based on validation performance. For example, parameter freezing module 1001 decides to freeze the parameters of first model 553 when the validation accuracy for the first model 553 remains constant across multiple validations datasets included in first validation data 1020, such as when the validation loss reaches a minimum and remains stable. Additionally, parameter freezing module 1001 determines to freeze the parameters of first model 553 based on cross-task performance. For example, parameter freezing module 1001 checks whether freezing the parameters of first model 553 leads to stable or improved performance of second model 554, expert models 556, and hierarchical MoE model 516.

At step 1540, parameter freezing module 1001 freezes the parameters of first model 553 and model trainer 515 trains expert models 556, hierarchical MoE model 516, and second model 554 using second training data 1011. In various embodiments, once the parameters of first model 553 are frozen during the forward pass, second training features from second training data 1011 are provided to expert models 556 and hierarchical MoE model 516, which also receives expert outputs 605. Hierarchical MoE model 516 uses the second training features to mix various expert outputs 605 and provides the mixed expert outputs to first model 553, with frozen parameters, and second model 554. First model 553 processes the mixed expert outputs and generates intermediate outputs 603, which are then provided to second model 554. Second model 554 processes both the mixed expert outputs and the intermediate outputs 603 to generate final output 602. Loss calculation module 1002 compares the final output 602 with the ground truth final output in second training data 1011, calculating a loss. In some examples, loss calculation module 1002 calculates the loss based on the difference between the predicted and actual streaming probabilities for rows. During the backward pass, backpropagation module 1003 computes the gradients based on loss and propagates the gradients through expert models 556, hierarchical MoE model 516, and second model 554 to update the parameters. Backpropagation module 1003 uses gradient descent techniques, including regularization methods such as dropout or L2 regularization, to prevent overfitting.

At step 1550, model trainer 515 checks whether a stopping criterion is met. In various embodiments, model trainer 515 trains hierarchical MoE model 516, expert models 556, and second model 554 until a stopping criterion is met, such as achieving a specific level of validation accuracy using second validation data 1021, reaching a plateau in the training loss, or completing a predefined number of training epochs. If a stopping criterion is not met, the method returns to step 1540. If a stopping criterion is met, the method proceeds to step 1560.

At step 1560, model trainer 515 saves first model 553, second model 554, expert models 556, hierarchical MoE model 516, and second model′ 1030. In various embodiments, once model trainer 515 completes training hierarchical MoE model 516, expert models 556, first model 553, and second model 554, model trainer 515 stores the trained models in data store 520. In at least one embodiment, model trainer 515 also creates second model′ 1030 as a replica of the trained second model 554. In some examples, when second model 554 is a neural network, second model′ 1030 shares the same layers and/or parameters, ensuring that the parameters remain synchronized with second model 554.

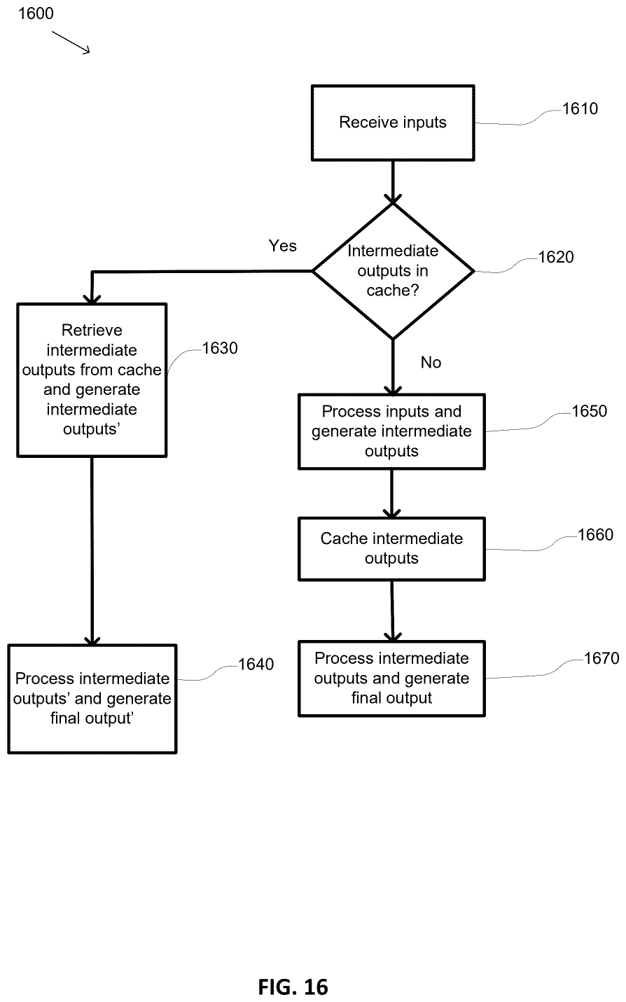

FIG. 16 sets forth a flow diagram of method steps for inferencing final output 602 with cached intermediate outputs 603, according to various embodiments. Although the method steps are described in conjunction with the systems of FIGS. 11, 13A, 13B, and FIG. 16, persons skilled in the art will understand that any system configured to perform the method steps in any order falls within the scope of the present disclosure.

The method 1600 begins with step 1610, where first model 553 receives inputs. In various embodiments, first model 553 receives first shared expert outputs 720 and first expert outputs 719.

At step 1620, cache lookup module 1110 checks whether intermediate outputs 603 are available in cache 548. Cache lookup module 1110 generates a key based on the first shared expert outputs 720 and first expert outputs 719. Cache lookup module 1110 searches the lookup table to determine if the key matches a key in an entry stored in cache 548. If the key matches a key in an entry, then intermediate outputs 603 are available in cache 548, and the method proceeds to step 1630. If the key does not match any of the keys stored in entries, intermediate outputs 603 are not available in cache 548, and the method proceeds to step 1640.

At step 1630, cache lookup module 1110 retrieves intermediate outputs 603 from cache 548 and generates intermediate outputs′ 604. Cache lookup module 1110 reads the entry corresponding to the key generated during step 1620 and then extracts intermediate outputs′ 604 from the entry.

At step 1640, second model′ 1102 processes intermediate outputs′ 604 and generate final output′ 1104. In various embodiment, second model′ 1102 then processes intermediate outputs′ 604, second shared expert outputs 717, and second expert outputs 718 and generates final output′ 1104.

At step 1650, first model 553 processes inputs and generates intermediate outputs 603. In some embodiments, first model 553 processes first shared expert outputs 720 and first expert outputs 719 and generates intermediate outputs 603.

At step 1660, intermediate output caching module 1101 caches intermediate outputs 603. Intermediate output caching module 1101 generates a key based on first expert outputs 719 and first shared expert outputs 720. Intermediate output caching module 1101 stores intermediate outputs 603, along with the corresponding key, in cache 548.

At step 1670, second model 554 processes intermediate outputs 603 and generates final output 602. In various embodiments, second model 554 processes second shared expert outputs 717, second expert outputs 718, and intermediate outputs 603 and generates final output 602.

In sum, the disclosed techniques include a hierarchical MoE model that integrates multiple expert models and various gating mechanisms to process input features and generate recommendations. The hierarchical MoE model includes a first model and a second model, where the output from the first model is provided to the second model. In various embodiments, input features are pre-processed and then provided to various expert models. The outputs from the expert models are then mixed using various gating weights included in gating mechanisms. The first model processes the mixed expert outputs and generates intermediate outputs. The second model then processes intermediate outputs as well as mixed expert outputs and generates final outputs, such as recommendations with confidences.

The disclosed techniques also include training the hierarchical MoE model based on a first and a second set of training data. The training process begins by concurrently training the first model and second model based on expert outputs from a first set of training data. During training, the output from the first model is provided to the second model, the outputs of the second model are compared to ground truth, and a loss is calculated. The loss is used in a backpropagation algorithm to update the parameters of the hierarchical model, first model, and second model. A performance metric is continuously evaluated to determine if a predefined criterion is met. If the criterion is met, the first model's parameters are frozen. Subsequently, the second model is further trained using expert outputs from a second set of training data. The training continues until a stopping criterion is met.

The disclosed techniques further include a multi-level scoring module for inferencing using the trained hierarchical MoE model. Inferencing starts with receiving a first set of inputs. The disclosed techniques check whether the intermediate outputs are available in a cache. If the intermediate outputs are not available in the cache, the first set of inputs are processed by the first model to generate intermediate outputs. The intermediate output are then cached. If the intermediate outputs are available in the cache, then the intermediate outputs are retrieved from cache. The intermediate outputs are presented to the second model to generate a final output, such as recommendations with associated confidences.

At least one technical advantage of the disclosed techniques relative to the prior art is that, with the disclosed techniques, diverse and personalized recommendations can be generated that address a wide range of user preferences and contexts. The disclosed techniques dynamically balance shared and task-specific knowledge, ensuring that the most relevant and diverse recommendations are provided to each user. Another advantage of the disclosed techniques is the ability to address the cold start problem by recommending new or less popular items for users from sparse interaction data. Yet another advantage of the disclosed techniques is the reduction in computational cost compared to conventional recommendation systems by reusing previously computed results and minimizing redundant calculations, which reduces the computational burden associated with analyzing and comparing a large number of item attributes or user interactions. These technical advantages provide one or more technological improvements over prior art approaches.
1. In some embodiments, a computer-implemented method for generating recommendations using a hierarchical model comprises processing input features to generate pre-processed input features, processing the input features and the pre-processed input features using a plurality of expert models to generate expert outputs, mixing the input features and the expert outputs to generate mixed expert outputs, processing the mixed expert outputs using a first model of the hierarchical model to generate intermediate outputs, and processing the mixed expert outputs and the intermediate outputs using a second model of the hierarchical model to generate a final output.
2. The computer-implemented method of clause 1, wherein the plurality of expert models include first expert models for processing input features for the first model, second expert models for processing input features for the second model, and third expert models for processing input features for both the first model and the second model.
3. The computer-implemented method of clauses 1 or 2, wherein mixing the input features and the expert outputs comprises combining the input features and outputs from the first expert models to generate first inputs for the first model, combining the input features and outputs from the second expert models to generate second inputs for the second model, and combining the input features and outputs from the third expert models to generate third inputs for the first model and fourth inputs for the second model.
4. The computer-implemented method of any of clauses 1-3, wherein combining the input features and outputs from the first expert models comprises generating gating weights.
5. The computer-implemented method of any of clauses 1-4, wherein generating the gating weights comprises generating attention scores for the outputs from the first expert models.
6. The computer-implemented method of any of clauses 1-5, wherein processing the input features to generate the pre-processed input features comprises extracting features for rows or groups of content that are most likely to be of interest to a user.
7. The computer-implemented method of any of clauses 1-6, wherein processing the input features to generate the pre-processed input features comprises extracting features based on preferences of a user.
8. The computer-implemented method of any of clauses 1-7, wherein the input features include one or more of row features, page features, video features, or user features.
9. The computer-implemented method of any of clauses 1-8, further comprising caching the intermediate outputs to generate cached intermediate outputs, and in response to determining that second input features correspond to the cached intermediate outputs, processing the mixed expert outputs and the cached intermediate outputs using a replica of the second model to generate to a second final output.
10. The computer-implemented method of any of clauses 1-9, wherein the hierarchical model is trained using positive training features included in a log and a subset of negative training features included in the log.
11. The computer-implemented method of any of clauses 1-10, wherein the first model ranks entities within groups of entities, and the second model recommends groups of entities to display to a user.
12. The computer-implemented method of any of clauses 1-11, wherein the entities correspond to media content items.
13. In some embodiments, one or more non-transitory, computer-readable media include instructions that, when executed by one or more processors, cause the one or more processors to perform the steps of processing input features to generate pre-processed input features, processing the input features and the pre-processed input features using a plurality of expert models to generate expert outputs, mixing the input features and the expert outputs to generate mixed expert outputs, processing the mixed expert outputs using a first model of a hierarchical model to generate intermediate outputs, and processing the mixed expert outputs and the intermediate outputs using a second model of the hierarchical model to generate a final output.
14. The one or more non-transitory, computer-readable media of clause 13, wherein the plurality of expert models include first expert models for processing input features for the first model, second expert models for processing input features for the second model, and third expert models for processing input features for both the first model and the second model.
15. The one or more non-transitory, computer-readable media of clauses 13 or 14, wherein mixing the input features and the expert outputs comprises combining the input features and outputs from the first expert models to generate first inputs for the first model, combining the input features and outputs from the second expert models to generate second inputs for the second model, and combining the input features and outputs from the third expert models to generate third input for the first model and fourth inputs for the second model.
16. The one or more non-transitory, computer-readable media of any of clauses 13-15, wherein combining the input features and outputs from the first expert models comprises generating gating weights.
17. The one or more non-transitory, computer-readable media of any of clauses 13-16, wherein processing the input features to generate the pre-processed input features comprises at least one of extracting features for rows or groups of content that are most likely to be of interest to a user or extracting features based on preferences of a user.
18. The one or more non-transitory, computer-readable media of any of clauses 13-17, wherein the steps further comprise caching the intermediate outputs to generate cached intermediate outputs, and in response to determining that second input features correspond to the cached intermediate outputs, processing the mixed expert outputs and the cached intermediate outputs using a replica of the second model to generate to a second final output.
19. The one or more non-transitory, computer-readable media of any of clauses 13-18, wherein the first model ranks entities within groups of entities, and the second model recommends groups of entities to display to a user.
20. In some embodiments, a recommendation system comprises a hierarchical model comprising a first model and a second model, wherein output from the first model is provided to the second model, a plurality of expert models preprocessing input features for the hierarchical model, the plurality of expert models including first expert models for preprocessing input features for the first model, second expert models for preprocessing input features for the second model, and third expert models for preprocessing input features for both the first model and the second model, a first gating network combining outputs from the first expert models to generate input for the first model, a second gating network combining the input features and outputs from the third expert models to generate input for the first model, a third gating network combining the input features and outputs from the second expert models to generate input for the second model, and a fourth gating network combining outputs from the third expert models to generate input for the second model. Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating recommendations using a hierarchical model, the method comprising:
processing input features to generate pre-processed input features;
processing the input features and the pre-processed input features using a plurality of expert models to generate expert outputs;
mixing the input features and the expert outputs to generate mixed expert outputs;
processing the mixed expert outputs using a first model of the hierarchical model to generate intermediate outputs; and
processing the mixed expert outputs and the intermediate outputs using a second model of the hierarchical model to generate a final output.

2. The computer-implemented method of claim 1, wherein the plurality of expert models include first expert models for processing input features for the first model, second expert models for processing input features for the second model, and third expert models for processing input features for both the first model and the second model.

3. The computer-implemented method of claim 2, wherein mixing the input features and the expert outputs comprises:
combining the input features and outputs from the first expert models to generate first inputs for the first model;
combining the input features and outputs from the second expert models to generate second inputs for the second model; and
combining the input features and outputs from the third expert models to generate third inputs for the first model and fourth inputs for the second model.

4. The computer-implemented method of claim 3, wherein combining the input features and outputs from the first expert models comprises generating gating weights.

5. The computer-implemented method of claim 4, wherein generating the gating weights comprises generating attention scores for the outputs from the first expert models.

6. The computer-implemented method of claim 1, wherein processing the input features to generate the pre-processed input features comprises extracting features for rows or groups of content that are most likely to be of interest to a user.

7. The computer-implemented method of claim 1, wherein processing the input features to generate the pre-processed input features comprises extracting features based on preferences of a user.

8. The computer-implemented method of claim 1, wherein the input features include one or more of row features, page features, video features, or user features.

9. The computer-implemented method of claim 1, further comprising:
caching the intermediate outputs to generate cached intermediate outputs; and
in response to determining that second input features correspond to the cached intermediate outputs, processing the mixed expert outputs and the cached intermediate outputs using a replica of the second model to generate to a second final output.

10. The computer-implemented method of claim 1, wherein the hierarchical model is trained using positive training features included in a log and a subset of negative training features included in the log.

11. The computer-implemented method of claim 1, wherein:
the first model ranks entities within groups of entities; and
the second model recommends groups of entities to display to a user.

12. The computer-implemented method of claim 11, wherein the entities correspond to media content items.

13. One or more non-transitory, computer-readable media including instructions that, when executed by one or more processors, cause the one or more processors to perform the steps of:
processing input features to generate pre-processed input features;
processing the input features and the pre-processed input features using a plurality of expert models to generate expert outputs;
mixing the input features and the expert outputs to generate mixed expert outputs;
processing the mixed expert outputs using a first model of a hierarchical model to generate intermediate outputs; and
processing the mixed expert outputs and the intermediate outputs using a second model of the hierarchical model to generate a final output.

14. The one or more non-transitory, computer-readable media of claim 13, wherein the plurality of expert models include first expert models for processing input features for the first model, second expert models for processing input features for the second model, and third expert models for processing input features for both the first model and the second model.

15. The one or more non-transitory, computer-readable media of claim 14, wherein mixing the input features and the expert outputs comprises:
combining the input features and outputs from the first expert models to generate first inputs for the first model;
combining the input features and outputs from the second expert models to generate second inputs for the second model; and
combining the input features and outputs from the third expert models to generate third input for the first model and fourth inputs for the second model.

16. The one or more non-transitory, computer-readable media of claim 15, wherein combining the input features and outputs from the first expert models comprises generating gating weights.

17. The one or more non-transitory, computer-readable media of claim 13, wherein processing the input features to generate the pre-processed input features comprises at least one of extracting features for rows or groups of content that are most likely to be of interest to a user or extracting features based on preferences of a user.

18. The one or more non-transitory, computer-readable media of claim 13, wherein the steps further comprise:
caching the intermediate outputs to generate cached intermediate outputs; and
in response to determining that second input features correspond to the cached intermediate outputs, processing the mixed expert outputs and the cached intermediate outputs using a replica of the second model to generate to a second final output.

19. The one or more non-transitory, computer-readable media of claim 13, wherein:
the first model ranks entities within groups of entities; and
the second model recommends groups of entities to display to a user.

20. A recommendation system comprising:
a hierarchical model comprising a first model and a second model, wherein output from the first model is provided to the second model;
a plurality of expert models preprocessing input features for the hierarchical model, the plurality of expert models including first expert models for preprocessing input features for the first model, second expert models for preprocessing input features for the second model, and third expert models for preprocessing input features for both the first model and the second model;
a first gating network combining outputs from the first expert models to generate input for the first model;
a second gating network combining the input features and outputs from the third expert models to generate input for the first model;
a third gating network combining the input features and outputs from the second expert models to generate input for the second model; and
a fourth gating network combining outputs from the third expert models to generate input for the second model.
